(19) United States
(12) Patent Application Publication
(10) Pub. No.: US 2016/0027023 A1
(43) Pub. Date: Jan. 28, 2016

(54) SYSTEM AND METHOD FOR SHARING INFORMATION WITHIN AND OUTSIDE A LIFE SCIENCES COMPANY

(71) Applicant: DARSHAN KULKARNI, NORTH WALES, PA (US)

(72) Inventor: DARSHAN KULKARNI, NORTH WALES, PA (US)

(21) Appl. No.: 14/808,744

(22) Filed: Jul. 24, 2015

Related U.S. Application Data
(60) Provisional application No. 62/028,599, filed on Jul. 24, 2014.

(51) Int. Cl. G06Q 30/00; G06Q 50/22; G06Q 50/00; H04L 29/06; H04L 29/08

(52) U.S. Cl. CPC G06Q 30/018; H04L 63/08; H04L 67/22; G06Q 50/01; G06Q 50/22

(57) ABSTRACT

The present invention provides methods for obtaining, storing, sharing, tracking, and reviewing Encounters and Documents primarily within and outside Life Science Companies. The present invention also provides for products produced by the methods of the present invention and for apparatuses used to perform the methods of the present invention.

### CROSS-REFERENCE TO RELATED APPLICATIONS

This application claims priority to U.S. Provisional Application Ser. No. 62/028,599, filed Jul. 24, 2014, the contents of which is hereby incorporated by reference in its entirety for all purposes.

### FIELD OF THE INVENTION

The disclosed invention is in the field of communicating legal, regulatory, medical, pharmaco-economic and/or other information with individuals or groups of individuals inside and/or outside of a company. It is intended especially, but not exclusively, for use by Life Sciences Companies.

### BACKGROUND OF THE INVENTION

Drugs and medical devices are approved for specific uses. But it often happens that a drug which is effective for a given use may also be effective for a different use. For example, a drug intended to treat Disease A may be found to be effective in treating Disease B. A use of a drug for a disease or purpose for which the drug was not specifically approved is known as an “off-label” use. Conversely, a use of a drug for its approved purpose is called an “on-label” use.

Life Science Companies were traditionally not permitted to advertise off-label uses to the general public. However, recent updates from the U.S. Food and Drug Administration (FDA) suggest that there are ways by which such companies may distribute off-label information in addition to on-label and pharmaco-economic information.

In light of these and other requirements, some companies have internal policies that require specific off-label information to be provided only in response to a specific solicitation, and/or the policies may govern the type of information that may be given to healthcare providers, formulary committees, and members of the general public.

To avoid violation of regulations, regulations, expectations expressed in corporate integrity agreements, and guidances, Life Science Companies must keep detailed records of inquiries from healthcare providers and others, and of the responses made to such inquiries. A typical response may be the mailing of materials to the inquiring party. Because a Life Science Company may receive large numbers of inquiries regarding the use of its Products, the record keeping requirement becomes onerous. When the records are kept in paper form, it is difficult to retrieve relevant items, and it can be virtually impossible to perform meaningful analysis on the data.

Further, a successful Risk Evaluation Mitigation Strategies (REMS) program by the FDA may require that healthcare professionals review a specific training program before being authorized to access, prescribe, dispense or otherwise use a specific Product. The continued ability of a Company to sell a Product will depend on the FDA's perception of the success of the training associated with the Product. Failure to ensure that adequate training has occurred may result in the FDA withdrawing the Company's ability to continue selling the Product.

Additionally, Life Science Companies routinely sign contracts with a variety of providers, including clinicians, for a variety of reasons. For example, clinicians may be asked to sign confidentiality agreements, be speakers for the Company, participate on advisory boards, be part of clinical trials, etc. However, these agreements are then not readily accessible.

Thus, there is a need for a better record-keeping method and system that at least partially automates the management of Communications between a Life Science Company and third parties, including but not limited to clinicians, and the keeping of records required. The invention is directed to these and other important needs.

### SUMMARY OF THE INVENTION

The present invention provides methods comprising: authenticating a user; receiving at least one file after authenticating the user; storing the at least one file after the receiving; sharing the at least one file after the storing; collecting transfer of value amounts from the sharing; expiring the at least one file after a user-specified period of time; relending the at least one file; and updating the transfer of value amounts.

The present invention also provides systems that perform those methods. The system may comprise a server, and the server may comprise at least one computer communicatively connected to a computer network and communicatively connected to a database. The server may have stored thereon computer instructions that during execution cause the system to perform operations comprising: authenticating a user; receiving at least one file after authenticating the user; storing the at least one file after the receiving; sharing the at least one file after the storing; collecting transfer of value amounts from the sharing; expiring the at least one file after a user-specified period of time; relending the at least one file; and updating the transfer of value amounts.

The present invention further provides methods comprising: authenticating a representative; receiving at least one file after authenticating the representative; storing the at least one file after the receiving; sharing the at least one file with at least one user after the storing; tracking user data of the at least one file by the at least one user from the sharing; and cross-referencing the tracked user data with external database information associated with the at least one user.

The present invention also provides systems that perform those methods. The system may comprise a server, and the server may comprise at least one computer communicatively connected to a computer network and communicatively connected to a database. The server may have stored thereon computer instructions that during execution cause the system to perform operations comprising: authenticating a representative; receiving at least one file after authenticating the representative; storing the at least one file after the receiving; sharing the at least one file with at least one user after the storing; tracking user data of the at least one file by the at least one user from the sharing; and cross-referencing the tracked user data with external database information associated with the at least one user.

The present invention additionally provides methods comprising: authenticating a representative; receiving at least one training file after authenticating the representative; storing the at least one training file after the receiving; sharing the at least one training file with at least one user after the storing; tracking data of the at least one training file by the at least one user from the sharing; and reporting the tracked data.

The present invention also provides systems that perform those methods. The system may comprise a server, and the server may comprise at least one computer communicatively connected to a computer network and communicatively connected to a database. The server may have stored thereon computer instructions that during execution cause the system to perform operations comprising: authenticating a representative; receiving at least one training file after authenticating the representative; storing the at least one training file after the receiving; sharing the at least one training file with at least one user after the storing; tracking data of the at least one training file by the at least one user from the sharing; and reporting the tracked data.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates an embodiment of the present invention directed to providing a screen display as used by a Representative of a Life Sciences Company to identify a person Communicating with the Company;

FIG. 1A illustrates an embodiment of the present invention directed to providing a screen display that allows a Representative to choose the intended individual recipient of an Encounter;

FIG. 1B illustrates an embodiment of the present invention directed to providing a screen display that allows a Representative to choose an intended recipient Group for an Encounter;

FIG. 2 illustrates an embodiment of the present invention directed to providing a screen display showing available details about a Communicating party;

FIG. 3 illustrates an embodiment of the present invention directed to providing a screen display showing Encounters with an individual and/or Group and how an operator can initiate a new Encounter with a specific Communicating party;

FIG. 4 illustrates an embodiment of the present invention directed to providing a screen display showing the performing of a search by a Representative of a Life Sciences Company in response to a Communication with a Caller;

FIG. 5 illustrates an embodiment of the present invention directed to providing a screen display showing the full text of an item obtained in a search and enabling an operator to perform further functions;

FIG. 6 illustrates an embodiment of the present invention directed to providing a screen display showing items that have been selected as of interest and/or can be added;

FIG. 6A illustrates an embodiment of the present invention directed to providing a screen display representing an electronic communication from a Company Representative to a User or Group with attached Documents related to the Encounter;

FIG. 7 illustrates an embodiment of the present invention directed to providing a screen display representing an initial login screen;

FIG. 8 illustrates an embodiment of the present invention directed to providing a screen display showing how an operator can edit information on an inquiring party;

FIG. 9 illustrates an embodiment of the present invention directed to providing a screen display through which a User may report an adverse event;

FIG. 10 illustrates an embodiment of the present invention directed to providing a screen display from the viewpoint of a Caller and showing how a Caller can search all Encounters and Documents to find a specific Document or Encounter;

FIG. 11 illustrates an embodiment of the present invention directed to providing a screen display from the viewpoint of a Caller and showing what the Caller sees when reviewing a Document that does not require acknowledgement;

FIG. 11A illustrates an embodiment of the present invention directed to providing a screen display from the viewpoint of a Caller and showing what the Caller sees when reviewing a Document that requires acknowledgement;

FIG. 12 illustrates a flowchart summarizing the operation of an embodiment of the present invention from the point of view of a Medical Affairs Associate who has received a Communication from a third party;

FIG. 13 illustrates a flowchart summarizing the operation of an embodiment of the present invention from the point of view of a Caller after having spoken with a Company Representative;

FIG. 14 illustrates a flowchart summarizing the operation of an embodiment of the present invention with respect to the potential analysis of data obtained;

FIG. 15 illustrates an embodiment of the present invention directed to providing a screen display of the various Encounters as may be seen by a Caller, including, but not limited to targeted advertising;

FIG. 16 illustrates an embodiment of the present invention directed to providing a screen display of sharing of a Document or Encounter as may be performed by a User who is typically not a Company Representative;

FIG. 17 illustrates an embodiment of the present invention directed to providing a screen display of the various Encounters, typically relating to a specific Representative, as may be seen by that Representative;

FIG. 18 illustrates an embodiment of the present invention directed to providing a screen display of the various Encounters relating to a specific Document, as may be seen typically by a Representative;

FIG. 19 illustrates an embodiment of the present invention directed to sample classifications of professions inside a Company to illustrate how a Class, SuperClass and SubClass may be structured; and

FIG. 20 illustrates an embodiment of the present invention directed to sample classification of professions outside a Company to illustrate how a Class, SuperClass and SubClass may be structured.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. Any reference to a masculine term, e.g., “he” or “his,” also includes the feminine term, e.g., “she” or “hers,” and vice versa unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

TERMS

“Company,” or “Life Science Company,” as the term is used herein, is defined as a company that is regulated in whole or in part by the US Food and Drug Administration (FDA) or its equivalent in other countries. Examples include pharmaceutical or biopharmaceutical companies, or manufacturers of medical devices (collectively, “Pharmaceutical Companies” or “Life Science Companies”).

“Caller,” as the term is used herein, is defined as a User or Group of Users who are, will, or have Communicated with the Company by one or more media, including but not limited to telephone, electronic media, social media, physical interactions or regular mail.

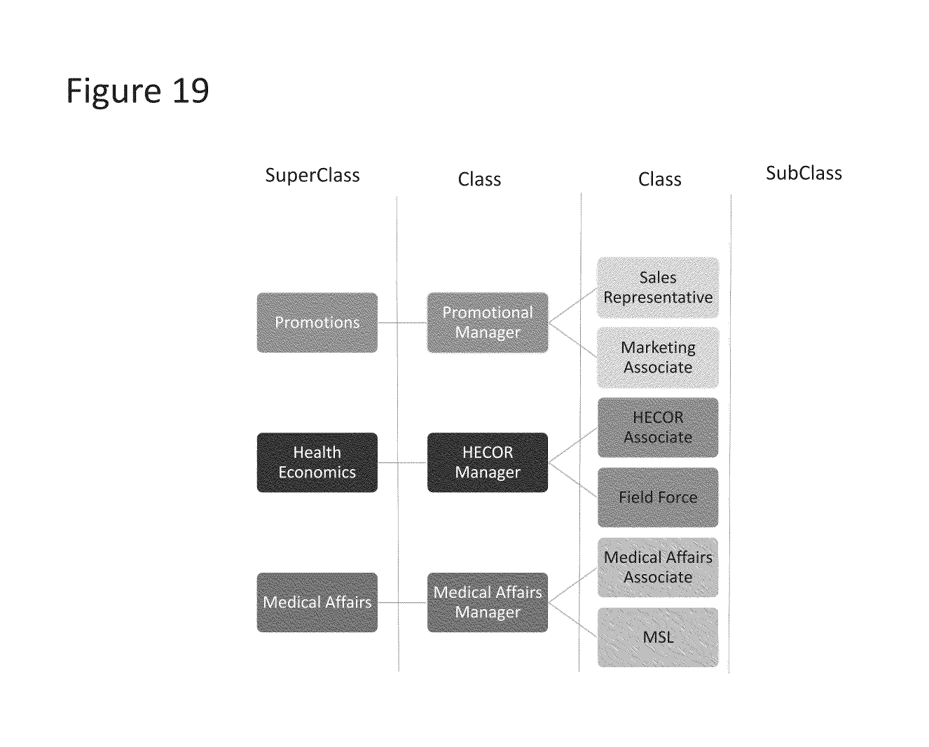

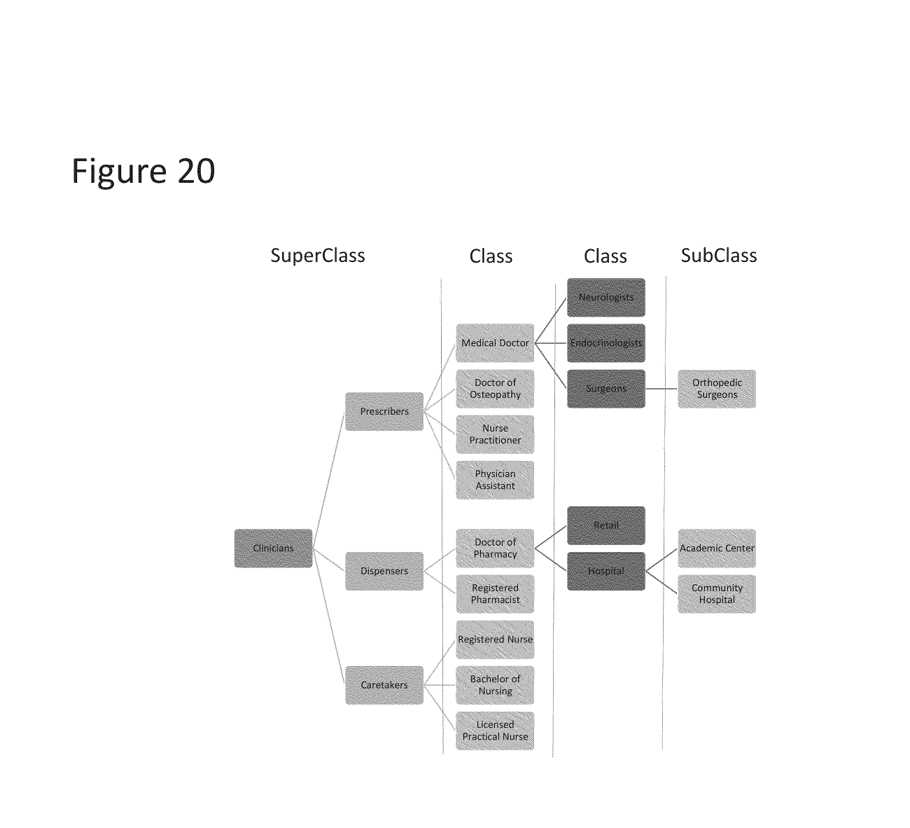

“Class,” as the term is used herein, is defined as a grouping of one or more individuals based on the rights and privileges they have. Individuals belonging to the same Class will have the same positive and negative rights. As shown in FIG. 19 and FIG. 20, it may be determined that only Users in a Manager Class can share specific Documents, or types of Documents, to specific Groups.

In an embodiment, a Class may comprise SubClasses. Multiple Classes together may form a SuperClass. SuperClasses, Classes, and Subclasses are all comprised of Users. As shown in FIG. 19, some Internal Classes include, but are not limited to, Medical Affairs Managers, Medical Science Liaisons, and Medical Affairs Associates. Accordingly, the Medical Affairs SuperClass is made up of Medical Affairs Managers, Medical Science Liaisons, and Medical Affairs Associates. Similarly, as shown in FIG. 20, External Classes include, for illustrative purposes only, Medical Doctors, Doctors of Osteopathy, Nurse Practitioners, Doctors of Pharmacy, etc. Additionally, the Medical Doctors Class itself includes Classes of Neurologists, Endocrinologists, and Surgeons.

“Comments,” as the term is used herein, is defined as comments left by a User to assist an individual or Group. There are a variety of audiences a Comment may be left for and/or be visible to. For example, in an embodiment, a Representative may insert Comments to help guide the Representative in future Encounters with a specific Caller. These Comments will not be seen by the Caller and may be associated with a Caller identification number, with a specific Encounter number, or with a Document. In an embodiment, a Representative may insert Comments to help to guide a Caller. These Comments will be seen by the Caller, and will appear each time this specific Encounter is retrieved or whenever the Caller contacts the Company, depending on the specific settings. Hence, a Comment may be associated with a Caller, an Encounter number, or a Document, and may be seen by the Representative, Group of Representatives, and/or the Caller or Group of Callers.

In an embodiment, Comments may be further classified based on the intended audience of the Comments. Comments may be applied in at least the following ways:

i. Caller Specific Unseen. The Representative inserts comments which help to guide the Representative in future Encounters with a specific Caller. These comments will not be seen by the Caller. These comments also will not appear every time this specific Document is retrieved, but will appear only when information on the specific Caller is retrieved by the Representative.

ii. Caller Specific Seen. The Representative inserts comments which help to guide a Caller. These comments will be seen by the Caller, and will appear each time a specific Document is retrieved. This type of comment will remind the Caller about important information which must be considered in the context of the specific Document.

iii. Internal Class Specific Seen. A Class, SubClass, or Super Class (collectively, “Group,” as defined below) may be internal, such as Medical Affairs Associates or Sales Representatives. In such an event, the Representative inserts comments which help to guide the members of the Group. If the recipient Group is internal to the Company, only members of the relevant Internal Group will be able to see the comments, e.g., comments made by a Promotions manager would only be visible to another Promotions manager, Marketing Associate, or Sales Representative, and could be made to be invisible to someone from the Medical Affairs SuperClass who may use the same Document.

iv. Internal Class Specific Unseen. The Representative inserts comments that help the Representative to guide members of an Internal Group. In such a situation, the comment may be made available to the Representative making the comment or to a specific Class he chooses to make the comment available to. For example, a Promotions Manager who uploads a new Document may want to remind himself and other Promotions Managers to remind the Sales Representatives and Marketing Associates about the importance of the Document for future projections, but does not want to provide this memory-jogging tip for the Sales Representatives and Marketing Associates to see.

v. External Class Specific Seen. A Group may be external (such as Neurologists, cardiologists in the Boca Raton area, etc.). If the recipient Group is external, the members of the Internal SuperClass who shared the Document and the members of the External Group to whom the message is directed will be able to see the Comment.

vi. External Class Specific Unseen. In such a situation, the Representative inserts comments that help the Representative to guide members of an External Group. The Comment may be made available to the Representative making the comment or to a specific Class he chooses to make the comment available to. For example, a Marketing Associate may want a reminder to tell any Marketing Associate giving this Document to a physician that the Document should be seen in conjunction with another Document to provide adequate scientific disclosure of the risks and benefits of a disclosed Product. This Comment need not be provided to the physicians themselves, but could serve as a memory-jogger for the Representative and/or the specific Class(es).

vii. Document Specific Unseen. The Representative inserts comments which help to guide the Representative in future Encounters with a specific Document. These comments will not be seen by a Caller, and will appear every time this specific Document is retrieved. This type of comment will remind the Representative about important information that must be considered in the context of the Document.

viii. Document Specific Seen. The Representative inserts comments which help to guide Callers in future Encounters with a specific Document. These comments will be seen by a Caller, and will appear every time this specific Document is retrieved. This type of comment will remind the Caller about important information that must be considered in the context of this Document.

All comments made may be available for the Information Technology (IT), Legal, and Compliance Classes to review.

“Communicate,” or “Communications,” as the term is used herein, is defined as any and all interactions by, between, among, and/or with Companies, including but not limited to electronic mail, phone conversations, social media interactions, in person interactions, etc. Communications include, but are not limited to, on and off-label uses and pharmaco-economics associated with Products, contracts, training, etc., to the extent permitted by law, regulation and guidance, and interpretations thereof.

“Company,” or “Life Sciences Company,” as the term is used herein, is defined as a company regulated by the FDA or its equivalent counterpart in another country that makes one or more Products.

“Document,” or “Documents,” as the term is used herein, is defined as information shared via the methods and systems disclosed herein as may occur in one or more formats and/or media, including but not limited to, PDF Documents, Documents generated by word processors, presentation software, electronic spreadsheets, video, audio, training, testing, interactive media, HTML Documents, etc.

“Field Force,” as the term is used herein, is defined as Classes of individuals who interface directly with individuals outside the company. As shown in FIG. 19, the Promotions SuperClass consists of at least two types of field forces: the Sales Representatives, and the Marketing Associates.

“Encounter,” as the term is used herein, is defined as an interaction between two or more individuals as recorded via the methods and systems disclosed herein. For example, a Document uploaded and saved into an embodiment of this disclosure for access by individuals in the Medical Affairs SuperClass would result in an Encounter. Similarly, a Document made available to a Medical Doctor by a Sales Representative would also result in an Encounter.

“External,” as the term is used herein, is defined as a third party. A third party may be an individual or Group that does not represent an employee or contractor of the Company, but is working on behalf of the Company. Example third parties include physicians or nurses who may have been hired to do work for the Company in a service-for-hire format, but are not employees of the Company and are unauthorized to represent the Company. Such individuals or Groups are typically Callers.

“Group,” as the term is used herein, is defined as a collection of one or more Classes, SuperClasses, and/or SubClasses.

“Internal,” as the term is used herein, is defined as an employee or Representative, which could be an individual or Group, that is authorized to represent the Company in a limited capacity. In an embodiment, the term may be applied to medical affairs personnel and/or sales representatives that may work for the Company and interact with Callers.

“Inquiry,” as the term is used herein, is defined as a request by a Caller for information, which may directly or indirectly result in sharing journal articles or other materials relating to that Communication.

“Managers,” or “Manager Class,” as the term is used herein, is defined as one or more types of managers who manage the Field Force of a particular SuperClass, e.g., the Promotional Manager manages Sales Representatives and the Marketing Associates. While each Class of the Field Force will have its own positive and negative rights, a Manager will typically have all the positive rights of the Field Force he is managing, but may not have all the negative rights. For example, the Promotions SuperClass may not be allowed to share a Document describing the off-label use of a drug with anyone in the Clinician Super Class. On the other hand, an embodiment may be configured so that an individual in the Manager Class in the Promotions SuperClass may be allowed to share a Document describing off-label uses in the context of an advisory board meeting, provided that a specific explanation is provided.

“Materials,” as the term is used herein, is defined as any Document or group of Documents, whether tangible or electronic.

“Off-label use,” as the term is used herein, is defined as a use of a drug for a disease or purpose for which the drug was not specifically approved.

“On-label use,” as the term is used herein, is defined as a use of a drug for its approved purpose.

“Product,” or “Life Sciences Product,” as the term is used herein, is defined as a pharmaceutical, biopharmaceutical, food, cosmetic, tobacco, food, nutraceutical, or medical device produced by a Company.

“Rental Period,” as the term is used herein, is defined as the period during which a specific Document is available for review by a specific User. A Rental Period can be of a fixed time period or may be permanent. The rental period may be set by a User based on a variety of factors including, but not limited to (1) a period that would reduce the transfer of value to less than a reportable transfer of value, and (2) a period that would optimize the sharing and resharing of documents so that (i) a Caller has adequate time to review a shared document and then return to the vault and reshare the document without inconvenience, and (ii) time is allowed for the maximum resharing of the document.

“Representative,” as the term is used herein, is defined as an individual authorized by a Company to act on its behalf within a limited capacity. Such Representatives include, but are not limited to, individuals belonging to the Promotions, Health Economics, and/or the Medical Affairs SuperClass, as described in FIG. 19, and/or a legal, compliance, regulatory affairs SuperClass, which is not described in the figures, but may be part of a Company.

“Rights,” as the term is used herein, is defined as the responsibilities and privileges provided to members of a Group based on the role of the Group. For example, an embodiment may prevent individuals belonging to the Promotions SuperClass from sharing any Document that is identified internally as containing off-label content. However, an exception may be created for Promotional Managers to share off-label content if it is for the purpose of setting up an advisory board meeting. Accordingly, the Promotions SuperClass will typically not have the Right to share off-label information, except for Promotional Managers who have the right in limited circumstances.

Rights may be positive or negative. Positive Rights are the rights that affirmatively allow a User of a specific Class to perform specific actions. For example, a User in the Medical Affairs Class would have the positive right to share off-label information. Similarly, a negative right is a Right that prevents a User of a specific Class from performing certain actions. For example, a User in the Promotions SuperClass will have a negative right to share off-label information and hence will not be able to share such off-label information.

Similarly, in an example embodiment, while it is possible for individuals belonging to the Promotions SuperClass to view data from third party sources regarding the impact of reading a specific Document on sales and prescribing, individuals belonging to the Medical Affairs SuperClass may not be granted similar rights to avoid any appearance of impropriety. Relatedly, individuals belonging to the Information Technology Class, Legal Class, and/or Compliance Class in a Company may be able to access all data created or shared by a Company to address any technology concerns, allow legal oversight, and allow for adequate compliance.

“Sunshine Act,” as the term is used herein, is defined as the Physician Payment Sunshine Act, or other state or local laws that govern the disclosure and control of the transfer of value between a Company and/or certain healthcare providers.

“SuperClass,” as the term is used herein, is defined as an aggregate of one or more Classes. FIGS. 19 and 20 illustrate SuperClasses. Typically, an Internal SuperClass may be made up of a Field Force and one or more types of Managers. Other examples of SuperClasses, as shown in FIG. 19, include the Promotions SuperClass and the Health Economics SuperClass.

As seen in FIG. 20, Prescribers, Dispensers, and Caretakers, would all belong to the SuperClass of Clinicians. Some examples of unillustrated SuperClasses therefore include NonClinicians, with their own Classes and SubClasses.

“SubClass” as the term is used herein, is defined as a subset of a Class. In this manner, a Class is made up of multiple SubClasses. SubClasses serve as a way to subdivide or filter information. For example, if a Company has multiple teams of Medical Affairs Associates, and only some of them support a specific drug Onogoloza, a SubClass may include those Medical Affairs Associates who support the drug Onogoloza. Similarly, as described in FIG. 20, for External SubClasses, Surgeons include a SubClass of Orthopedic Surgeons. Other possible SubClasses might include neurologists within the zip code of 19111 and/or Orthopedic Surgeons who prescribed a specific drug within a specified period of time, as may be confirmed by data from third party companies such as IMS or Doctors of Pharmacy working in a retail setting and serviced by a specific sales associate.

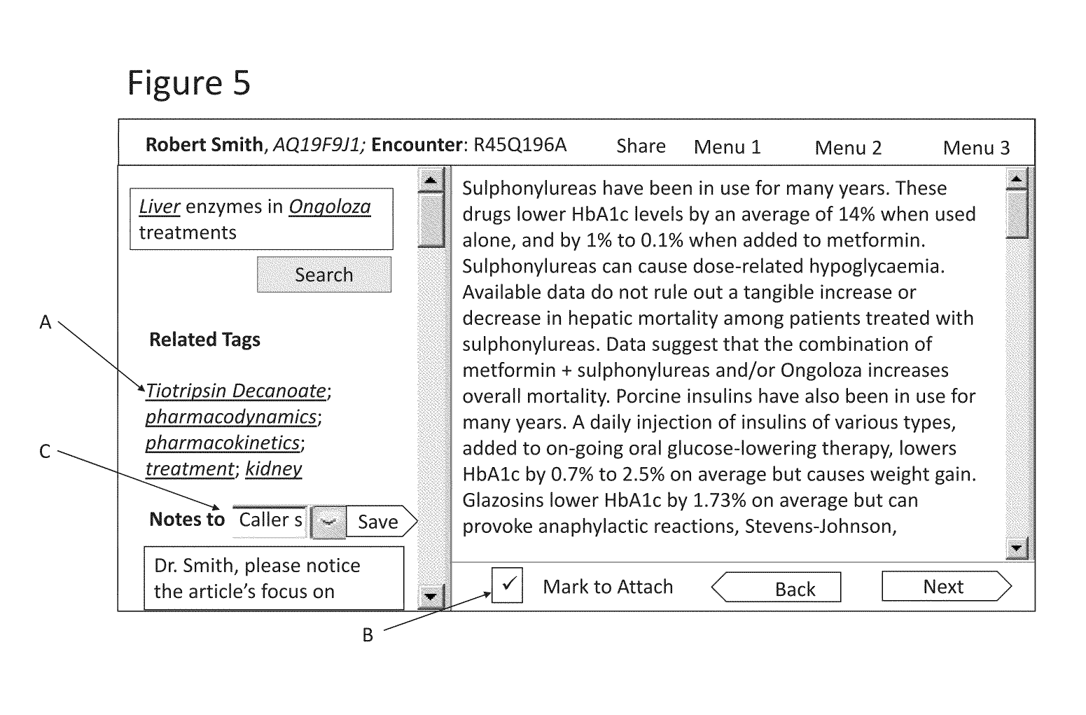

“Tags,” as the term is used herein, is defined as words or groups of words, as seen in FIG. 5 (A) that are related to the search, Product, Representative, and/or Caller, and are intended to remind the Representative to consider Communicating other relevant information with the Caller.

“User,” as the term is used herein, is defined as an individual who has access to the disclosed methods and systems and belongs to a specific Class. As shown in the example Classes in FIG. 19, an Internal User could be a “Sales Representative” or a “HECOR Associate” of some other department. Similarly, External Users, as shown in FIG. 20, may be Medical Doctors, Registered Nurses, etc. Depending on the type of User, certain positive rights or negative rights may be granted to him/her.

“Vault,” as the term is used herein, is defined as an electronic storage platform where one or more copies of a Document may be stored so that the Document can be rented temporarily or permanently. Once the Rental Period on a Document is completed, it returns to the Vault for future sharing, if sharing is allowed by the Company and/or any applicable copyright licenses. At the end of the Rental Period, the copy/reprint of the Document is no longer available to the previous renter.

The solution disclosed herein includes a method for the recording of one or more Communications between a Caller and a Company Representative, and the sharing and tracking of Documents relating to such interactions via mobile and non-mobile computer devices and a system capable of performing that method. Some embodiments may be used as a forum to share materials within and outside a Company. Specifically, embodiments may be used to share training Documents, previously signed contracts, power-point presentations, and other Documents, or to merely record Encounters. Some embodiments may ensure that a specific Document, as shared, was reviewed, which may be confirmed using an analytics function and/or an explicit confirmation, as may be requested from a receiving party. Some embodiments may allow a User to read a contract, and, if appropriate, sign the agreement electronically and then have continued access to the contract over an extended period of time. A goal of the disclosed methods and systems is to enable parties to have easier access to relevant information, while enabling the Company to keep track of the information provided.

An embodiment comprises a system for communicating information and tracking information between, amongst, and within Companies and their service providers, including and especially, but not limited to, clinicians. The system may comprise a programmed computer communicatively connected to a database, and the disclosed methods may comprise the programs executed by the computer.

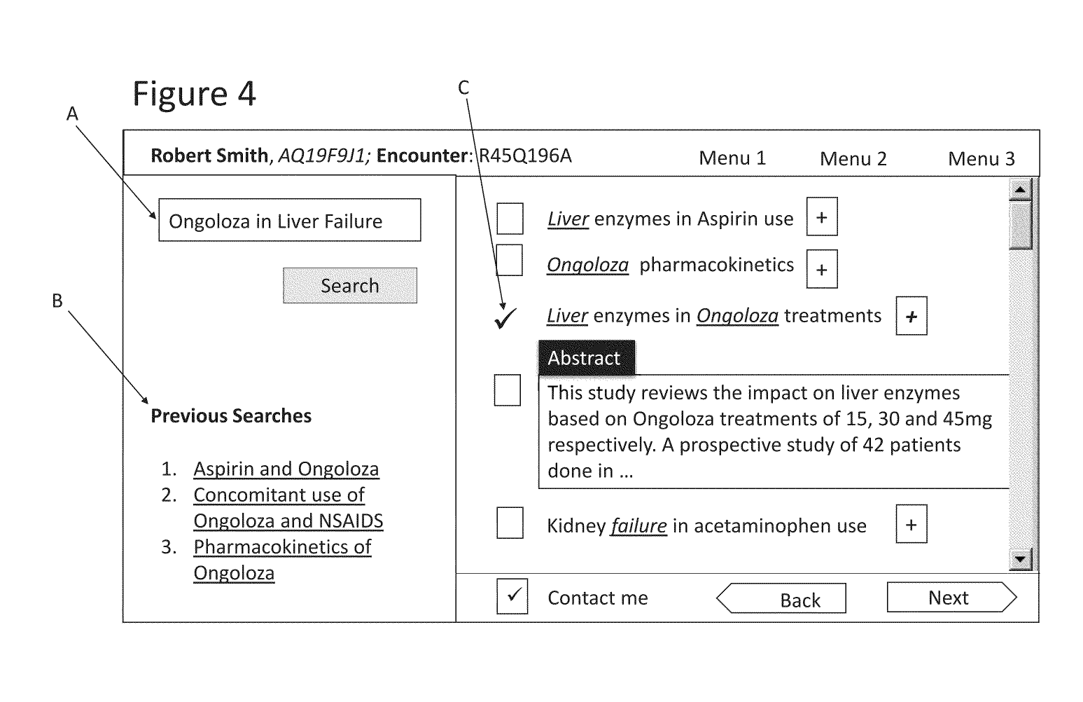

In some embodiments, if a Caller and a Representative communicate with each other, the Representative can register the Caller in the database if the Caller is not already registered. The Representative may then try to answer the Caller's questions orally and/or by supplementing with materials. The results of the Communications are tagged and associated with the specific Encounter between the Caller and the Company. The Caller is then given information which enables the Caller later to enter the database on an authenticated basis and view the items based on the Communication between the Representative and the Caller and shared by the Representative via the search function, as shown in FIG. 4 (A). If required, a Caller may be asked to agree to having viewed and/or having understood information presented and/or asked to Communicate his/her agreement with terms as presented.

Information generated by the above-described method can later be used to analyze specific information and/or trends in the data collected. The Company can thereby obtain insight into the level of interest in potential new uses of its Products, and this evidence may form the basis for new applications for approval for new uses. The information gained could also be used to target specific Groups.

Additionally, information regarding training provided by companies to clinicians may also be provided to the FDA to demonstrate that individual clinicians may obtain, prescribe, dispense or otherwise use specific drugs that have controlled access due to systems such as Risk Evaluation Mitigation Strategies (REMS).

Some embodiments may also demonstrate additional value to clinicians and other service providers by allowing Documents such as contracts between Companies and service providers to be shared. Therefore, a primary object of embodiments in this disclosure is to provide a system and method for communicating, storing, controlling, sharing, and analyzing medical and non-medical information.

Some embodiments in this disclosure have the further object of enabling a maker of drugs or medical devices to communicate with members of the public, while maintaining records of such communications.

Some embodiments in this disclosure have the further object of promoting the development of off-label uses of medical products, while ensuring compliance with applicable laws and regulations.

Some embodiments in this disclosure have the further object of enabling a manufacturer to gain insight on the use of its Products, and thereby to gauge the demand for new uses of its Products.

Some embodiments in this disclosure may further assist with the tracking and collection of information and transfers of value associated with the exchange of information.

Some embodiments in this disclosure have the object of allowing and/or preventing specific communications between one or more Groups of individuals to avoid violating various laws, regulations, guidances and/or lessons learned from Corporate Integrity Agreements (CIAs).

Some embodiments in this disclosure also allow only specific individuals to access, review, and/or share specific Documents based on their Class within a Group.

Some embodiments in this disclosure also allow individuals to collect and share adverse event information that may be collected as a result of interacting with this platform.

Some embodiments in this disclosure have the ability to provide reminders of conversations that should occur in light of current, previous or expected interactions with a Group.

Some embodiments in this disclosure also allow for the sharing of information including, but not limited to, Journal articles via social media platforms.

Some embodiments in this disclosure allow for the expiration and/or termination of access rights to specific documents.

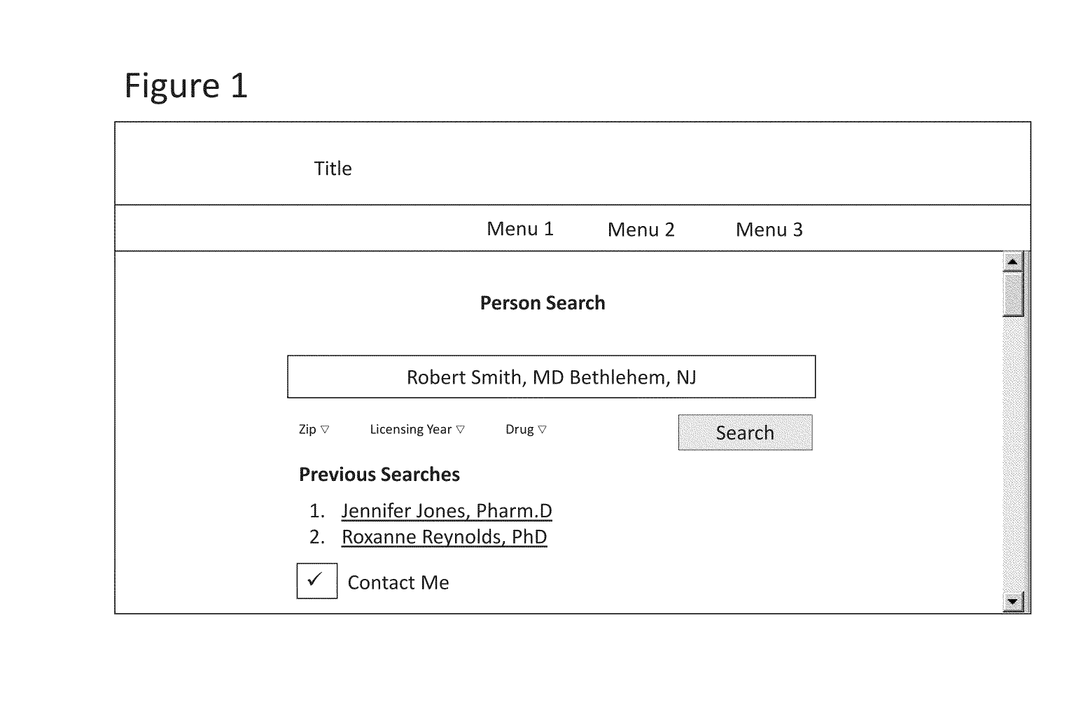

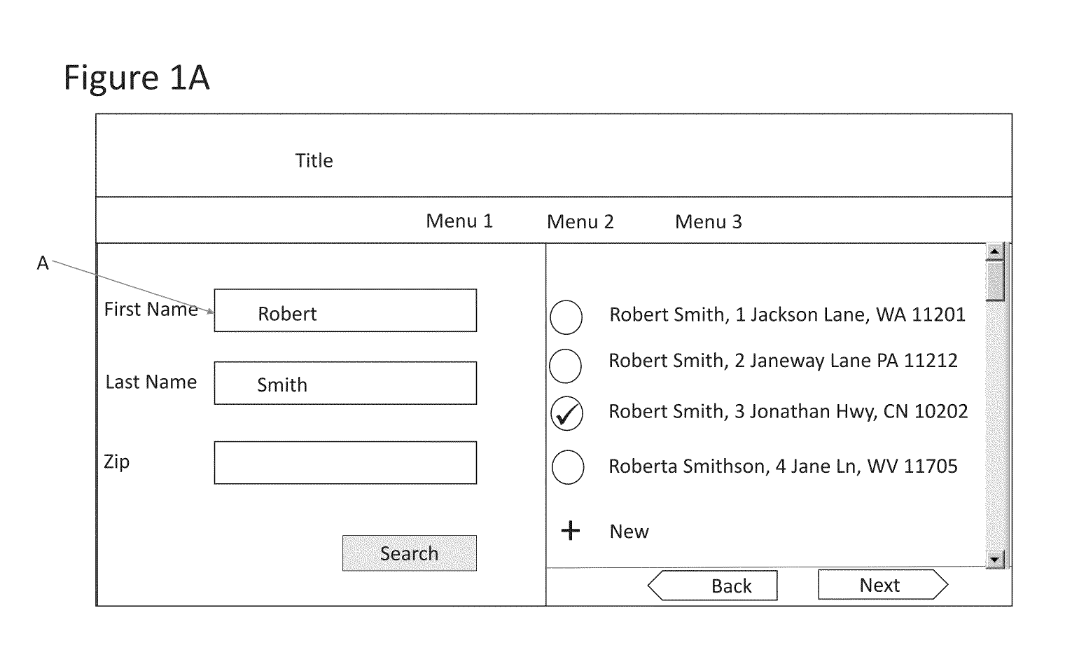

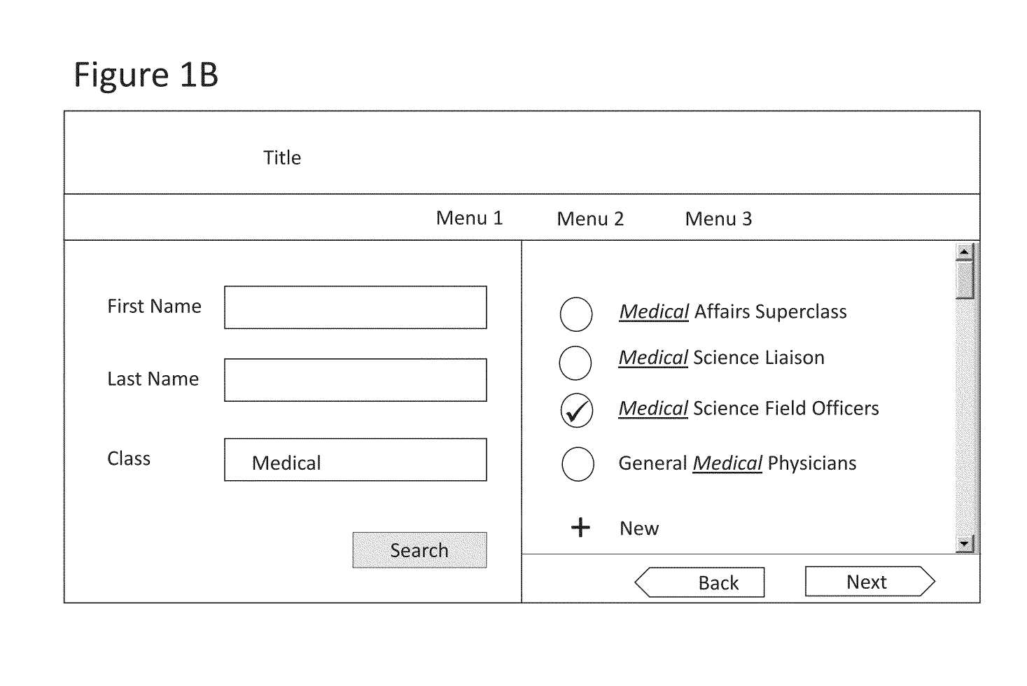

FIG. 1 provides an example embodiment showing a partial screen display of a computer system, which would be viewed by a User. A typical User of this screen would be a Representative of a Life Sciences Company. In the context of a Communication, the screen shown in FIG. 1 enables a Representative to search for the Recipient of the Communication.

As a result of a search done in FIG. 1, a plurality of options may present. FIG. 1A allows the User to filter the results via options on the left hand side (A), which can limit the plurality of choices, one of which could be the name of the Caller. The system might store such names in a database, as a result of a previous contact between the Caller and the Company, or as a result of other sources of information, such as information obtained from the Centers for Medicare & Medicaid Services. The system also allows for the possibility that the Caller is new, and the information about the Caller must be entered afresh.

The User selects the appropriate radio button in FIG. 1A, either by selecting one of the names presented, which comprise possible matches for the name entered on the left-hand side, or by selecting the button labeled “New”, which allows new information to be entered.

As seen in FIG. 1B, and in FIGS. 19 and 20, in certain circumstances the User can select not only a single User, but also a Group of Users.

The FDA and other governmental agencies have promulgated requirements around the types of Documents that can be shared with specific types of users. For example, while healthcare providers must be provided scientific information to enable them to make educated decisions, non-healthcare providers must be provided with information in easily readable language.

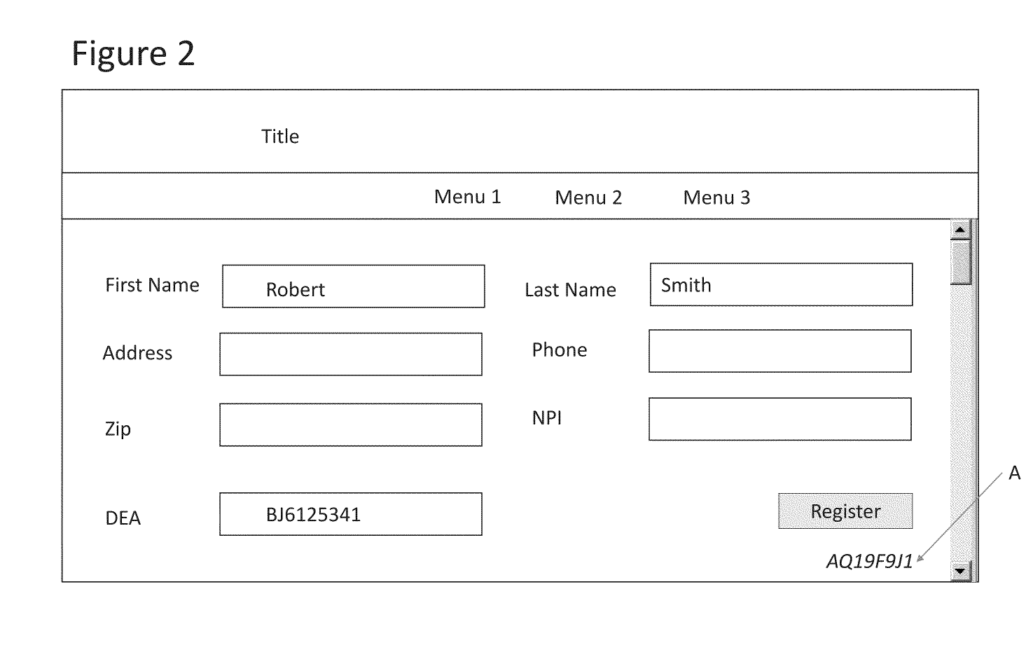

The screen of FIG. 1 also helps a User search for Callers based on various criteria including, but not limited to, whether the Caller is a healthcare provider or a non-healthcare provider based on information as may have been previously obtained in other screens, e.g., as shown in FIG. 2.

The results of FIG. 1 can, as shown in FIG. 1A and FIG. 1B, be filtered in a variety of ways, including, but not limited to, by name, educational degrees, address, telephone number, Drug Enforcement Agency Registration Number (“DEA number”), zip code, state license number, academic institutions where he/she practices, National Prescriber Identification Number (“NPI number”), Class of Caller, Comments added about the Caller, and any other criteria that may be beneficial for filtering. Based upon this information, the User will know the kind of information that may be released to the Caller.

FIG. 2 shows a partial screen display that confirms the Caller. It also provides information relating to the Caller. This information could relate to a pre-existing Caller, or could relate to a new Caller. This screen provides the first opportunity to add or edit information about the Caller. For new Callers, the Caller will be assigned a unique identification number, such as the “Assigned ID” shown near the bottom right corner of the screen (A). An embodiment includes a modification such that additional comments may be entered in an appropriate box.

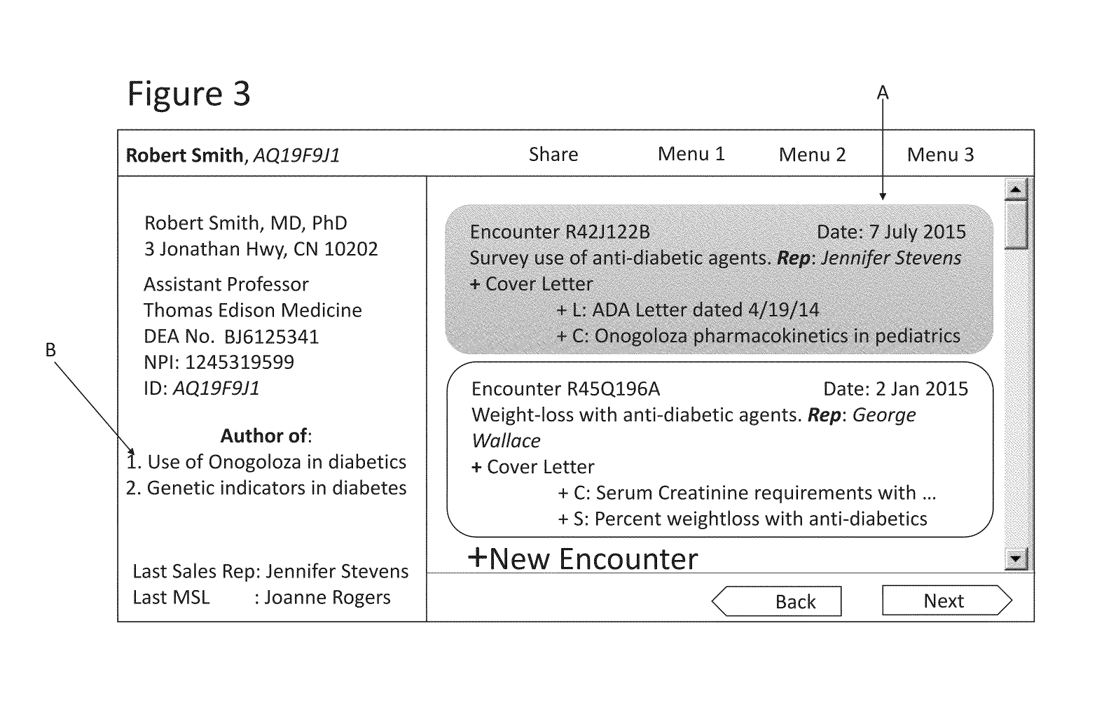

Once a Caller is confirmed from the screen shown in FIG. 2, the User can choose to append information to an existing “Encounter” with a Caller. FIG. 3 shows a partial screen display which lists various past Encounters between a particular Caller and the Company (if viewed by a Representative of the Company) or of multiple companies if appropriate authorization is provided. By selecting the appropriate Encounter, the User may append information to one of the previous Encounters, or the User may choose the “New Encounter” button to initiate a new Encounter. An Encounter may be characterized in a variety of ways, including as relating to an on-label or off-label use of a Product.

As seen in the example screen of FIG. 3, the left side of the screen shows important information about the Caller that may be used to confirm the identity of the Caller. For the purposes of this example screen, this information includes the name, address, job title, location of work, DEA Number, NPI Number, and unique identification number. Additionally, Documents where the Caller has been identified as an author will also be listed. The screen also identifies, for the Company, the last sales Company Representatives that visited the Caller. For the purposes of this screen, the last Company sales Representative was Jennifer Stevens, and the last Medical Science Liaison (“MSL”) was Joanne Rogers.

As can be seen in FIG. 3, there are two Encounters in this screen display. Encounter R42J122B (A) and has a general topic of “Survey use of anti-diabetic agents”. A cover letter is attached to this Encounter and two additional Documents are also attached. The Documents are classified for ease of use. The first Document is classified as a letter (L) dated Apr. 19, 2014 and the second is classified as a Clinical trial result (C) titled, “Onogoloza pharmacokinetics in pediatrics”. As previously described, Documents may be classified in a variety of ways. Example classifications include Surveys (S), Clinical Trial result (C), Videos (V), Letters (L), Infographics (I), etc.

FIG. 4 shows a screen display in which searches may be performed using a search box on the left-hand side. The search results, with or without summaries/abstracts of the links, may be displayed on the right-hand side. In the example embodiment shown, the Caller identification number and the Encounter number are shown at the top left. Various previous searches, associated with this Encounter, a previous Encounter, and/or otherwise associated with this Caller, Product, and/or User, are displayed on the bottom left-hand side (B). One or more Documents may be chosen to be attached to the Encounter, as shown by FIG. 4 (C), or as further described by FIG. 5(B). A User can also choose not to attach any Documents and choose to simply record an Encounter without attaching any Documents.

FIG. 4 shows each search result only as a brief title or heading. The User can choose to obtain more details in the next screen by selecting the check box corresponding to the search result of interest or see the abstract by using the “plus” sign next to the title. A sample expansion is shown for the Document titled, “Liver enzymes in Ongoloza treatments”. A contact box, shown along the bottom, can be checked by the User to indicate that a specific Caller is interested in being contacted by the Company to obtain samples, for further medical discussions, or any other pertinent reason.

FIG. 5 shows a screen display representing the consequence of making a choice at the screen illustrated in FIG. 4. In this example, the User has selected the search result labeled “Liver enzymes in Ongoloza treatments” in FIG. 4. FIG. 5 provides the full text of the selected item. The left-hand side provides “tags” which are related to the selected search result (A). Clicking on these tags will result in searches that are deemed relevant by the Company and/or its Representative. Specific types of tags can be enabled for specific types of searches. For example, searches by the promotions teams can be enabled to not result in off-label related tags, while those by the medical affairs team can be enabled to result in off-label results. Additional tags may be added by the Company Representative.

If the item shown in full on the right-hand side is deemed of interest, the User may “mark” an item with the “Mark to Attach” box shown at the bottom center of FIG. 5, indicating it is intended to be shared later with the Caller. By choosing which items to “mark”, the Representative can decide which Documents are appropriately responsive to the Caller and/or are of interest to the Caller and be will be shared with a specific Caller in light of a Communication.

The screen illustrated in FIG. 5 facilitates the communication between the Company and Callers concerning various types of Communications. The Company Representative may choose to write Comments and attach them to a Document retrieved in the search. In FIG. 5, this is seen in the case of the Comment attached in the bottom left side of FIG. 5, where the Comment, to the extent it can be seen, says, “Dr. Smith, please notice the article's focus on.” As can be seen in FIG. 5, the Comment is being saved, via a dropdown menu, to “Caller s . . . ” (C).

The “Share” button illustrated in FIG. 5, and other FIGs., also allows Documents to be shared using social media platforms including, but not limited to, Twitter, Facebook, etc.

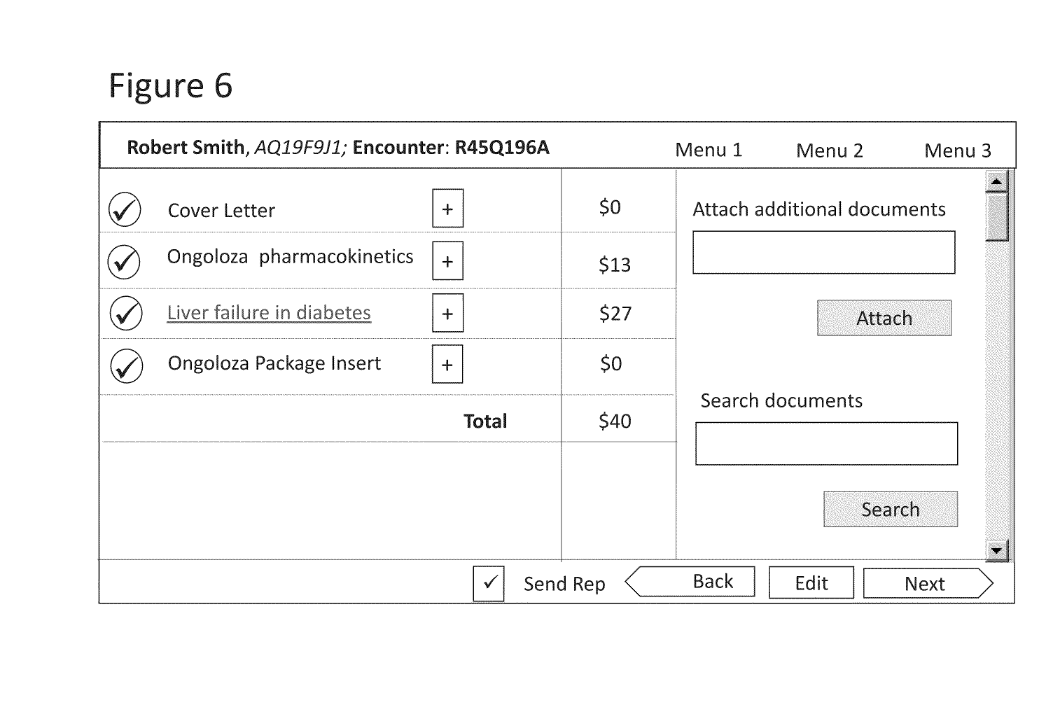

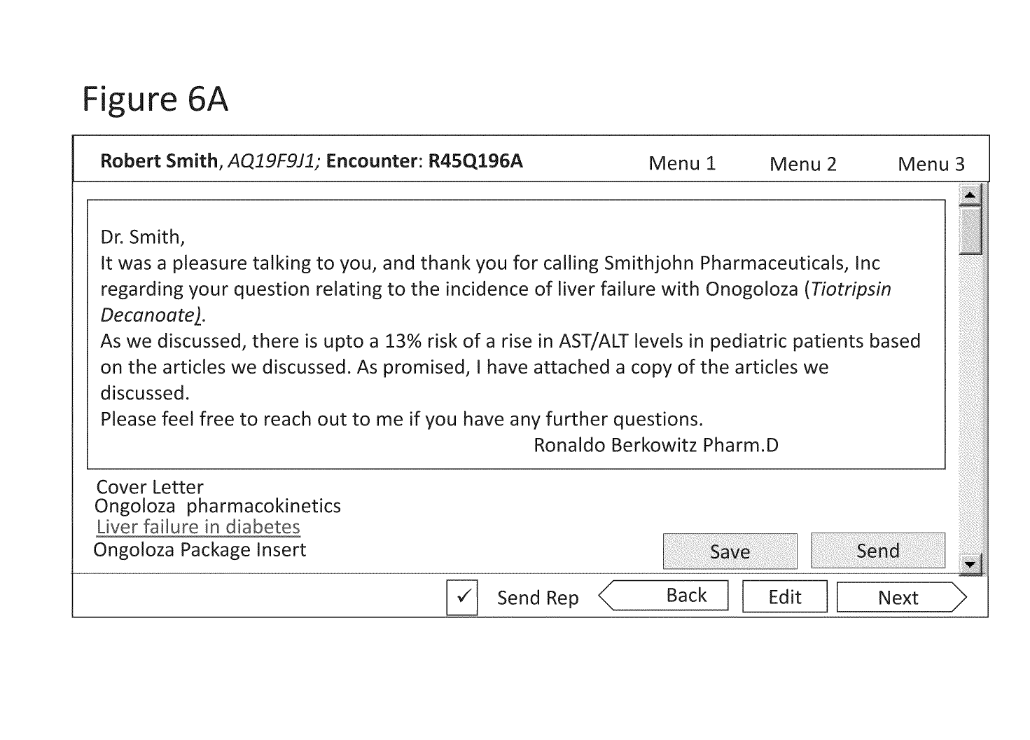

FIG. 6 shows an example screen display in which the User has chosen a specific Encounter, identified by the Encounter number shown in bold on the top left-center of the screen. On the left-hand side there are various items, comprising the items that have previously been “marked” by the User. These marked Documents are specific to a particular Encounter with a particular Caller. The User can choose at this point to “edit” the list of items that is being provided to the Caller, go back and review additional Documents, or continue through and complete the checkout. In addition to showing the list of selected Documents, this screen also serves to remind the User of the potential transfer of value that would occur if all of the marked Documents were “rented” to another User. This is useful for Sunshine Act reporting purposes where transfers of value must be reported because such transfers of value can be collected and then aggregated at the end of the year for specific Users, or Groups of Users. If necessary, additional Documents including, but not limited to, cover letters, audio files and/or transcripts relating to the actual Communication between a Representative and a User, dosing information, package inserts, etc., may also be attached to an Encounter as needed.

As previously described, an embodiment allows for recorded telephone calls or emails with Callers to be attached to a specific Encounter. This feature helps the Company ensure that a Document is in compliance with the applicable laws and regulations and facilitates the auditing of the Company as necessary. The feature may also work to remind Callers about the Communication.

An embodiment may also allow for the linking to various source materials of interest to healthcare providers. Such materials include, but are not limited to, websites relating to pending or completed clinical trials, patient diaries made during clinical trials, potential advertising materials, and other items. In the embodiment illustrated in FIG. 6, these additional materials or Documents may be attached via the search feature to search Documents already uploaded or otherwise available. Alternatively, these materials may be uploaded from the user's computer, via the right hand side of the screen shown in FIG. 6. A link to the Encounter can, if appropriate, be electronically mailed to the Caller from the next screen, shown in FIG. 6A, after clicking the “Next” button. As illustrated in FIG. 6A, an email can be sent to the specific user or Group of users with the various Documents attached, describing the content of the Encounter.

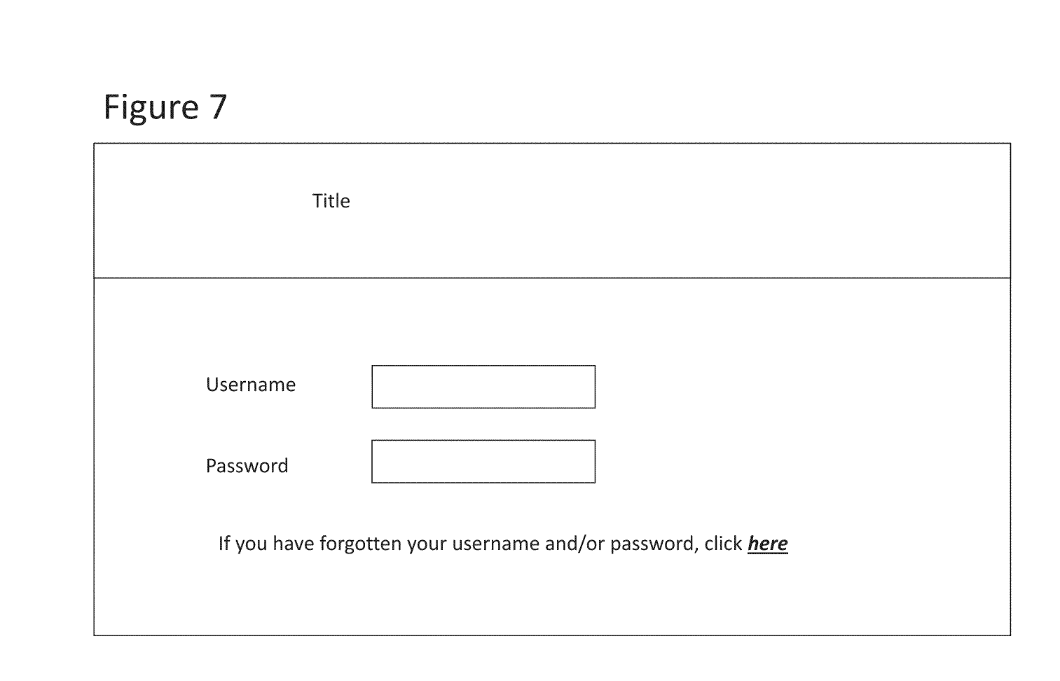

FIG. 7 shows an initial login screen of an embodiment. A User must enter a username and password in order to access data stored on the computer system. If the User has forgotten his/her username or password, he/she will be directed to a location to regenerate his/her password and/or be reminded of his/her username.

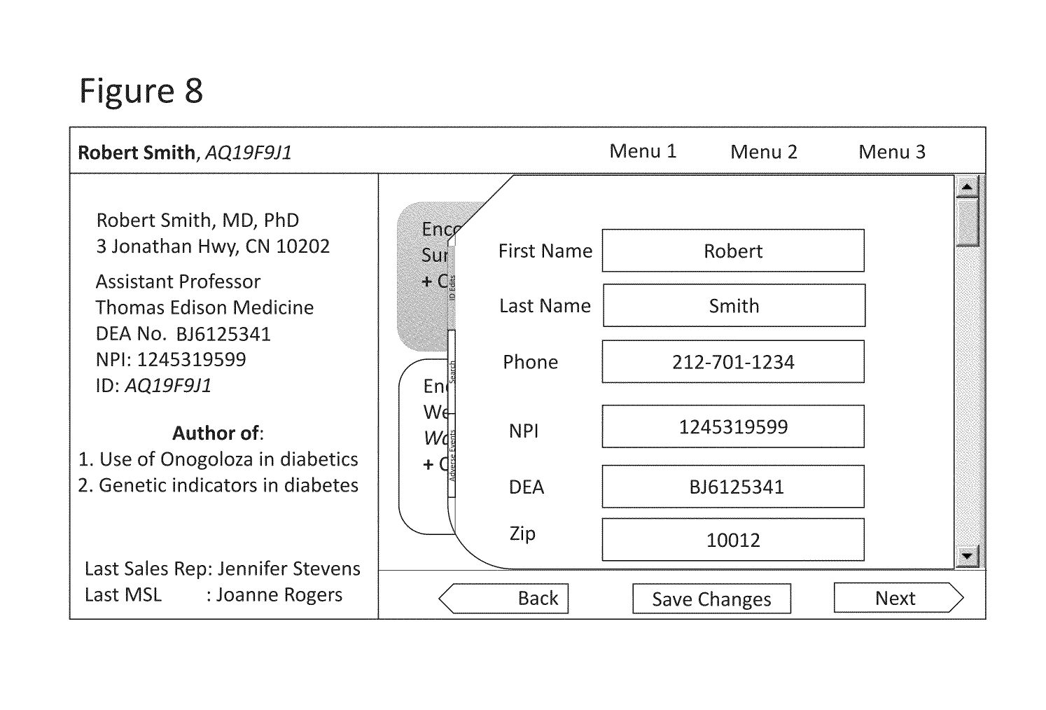

FIG. 8 shows an example screen display enabling the Company Representative to edit the information associated with a Caller. If appropriate, Callers may be given the Right to edit one or more fields. The display also enables information to be collected for a previously unidentified Caller. The modifiable and identifiable fields may be varied according to a variety of variables, including whether the Caller is a healthcare provider. For example, for a non-healthcare provider, the fields may include identification of the Products being used by the Caller as a patient of a healthcare provider. Additionally, it is possible to merge multiple Users if they are determined to be the same person. This will avoid duplication of information and allow for more specific information to be tracked and provided to the Company.

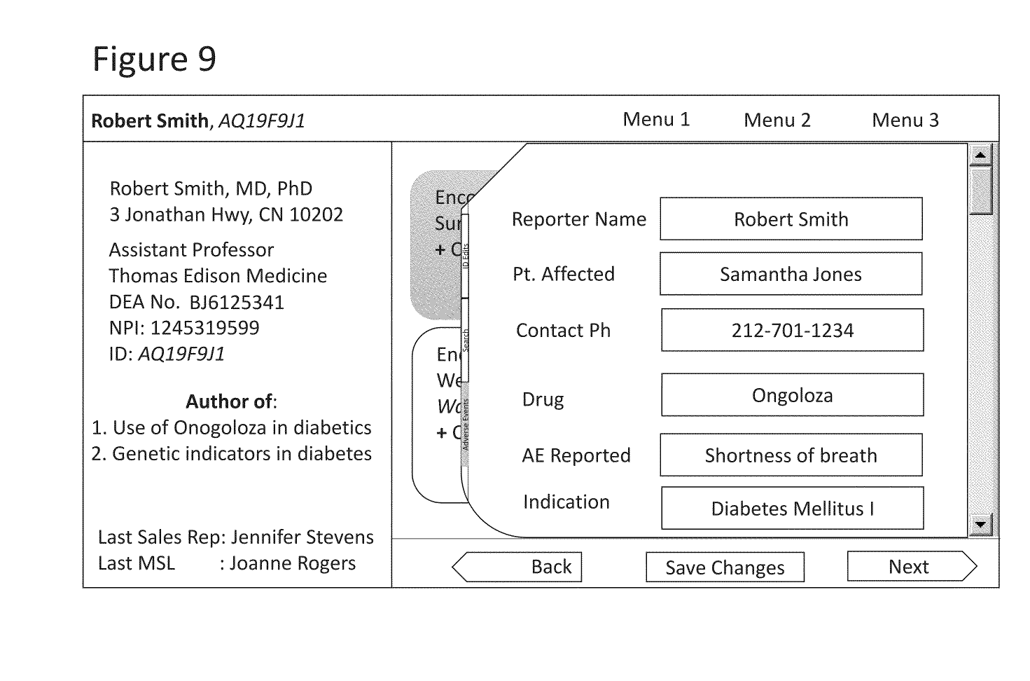

FIG. 9 illustrates an example screen display for use in reporting adverse events (AEs). When a healthcare provider reads a Document provided by the Company, the healthcare provider may recall that a particular patient experienced an adverse event. The same situation might also occur with a non-healthcare provider who remembers that he suffered an adverse event from the use of a Product. In these situations, the User may need to report the adverse event to the FDA or the Company. Embodiments allow such reporting of adverse events.

FIG. 9 illustrates the process of entering data relating to an adverse event. The information may be automatically transmitted to the Company, or even to the FDA. This screen display could be completed by any User, and the system may be setup to send the information directly to the Company's adverse event department so that appropriate follow-up can occur. An additional follow-up may be sent to the relevant governmental authorities, if appropriate. The fields on this screen may be auto-filled to the extent possible with available information. For example, if a specific Caller has called in, or if that Caller is logged in, the identity of the Caller may be auto-filled as the reporter of the adverse event.

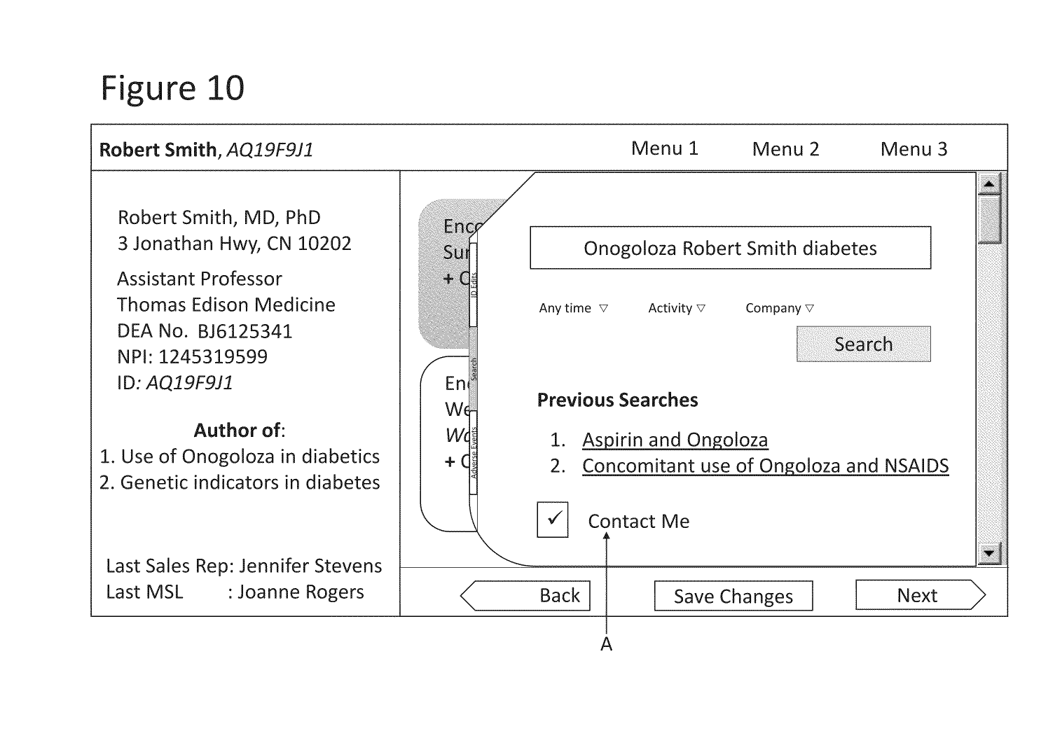

The example embodiment shown in FIG. 10 includes a pull-out menu that allows a User to perform searches within, or for, Documents and/or Encounters. Searches may be conducted against Documents and/or Encounters that have already been shared with the User. Accordingly, an Internal User may search all Documents owned by the Company that are available to his Group. Conversely, an External User may be able to search all Documents shared with him by any Company to the extent such results are still available; Documents may have been withdrawn and/or the Rental Period may have expired. Alternatively, a Company may choose to allow searches to Documents that have been withdrawn or that the Rental Period has expired for, but decline to provide access to read those Documents. Additionally, the embodiment shown in FIG. 10 also provides a list of former searches to allow for frequent searches to be repeated easily. Searching only within Documents that have been previously shared with the User allows the absence of impropriety of off-label Document sharing.

At the bottom of the display shown in FIG. 10, and also present in other displays, a “Contact Me” checkbox or button (collectively “checkbox”) is available (A). Such a checkbox enables the Caller to request that a Company Representative contact the Caller. This feature can be used when the Caller has questions or desires additional information. The checkboxes may be customized to be more specific. For example, an embodiment may be designed such that the request is directed to a particular department in the Company, such as Medical Affairs, Sales, Clinical Trials, etc.

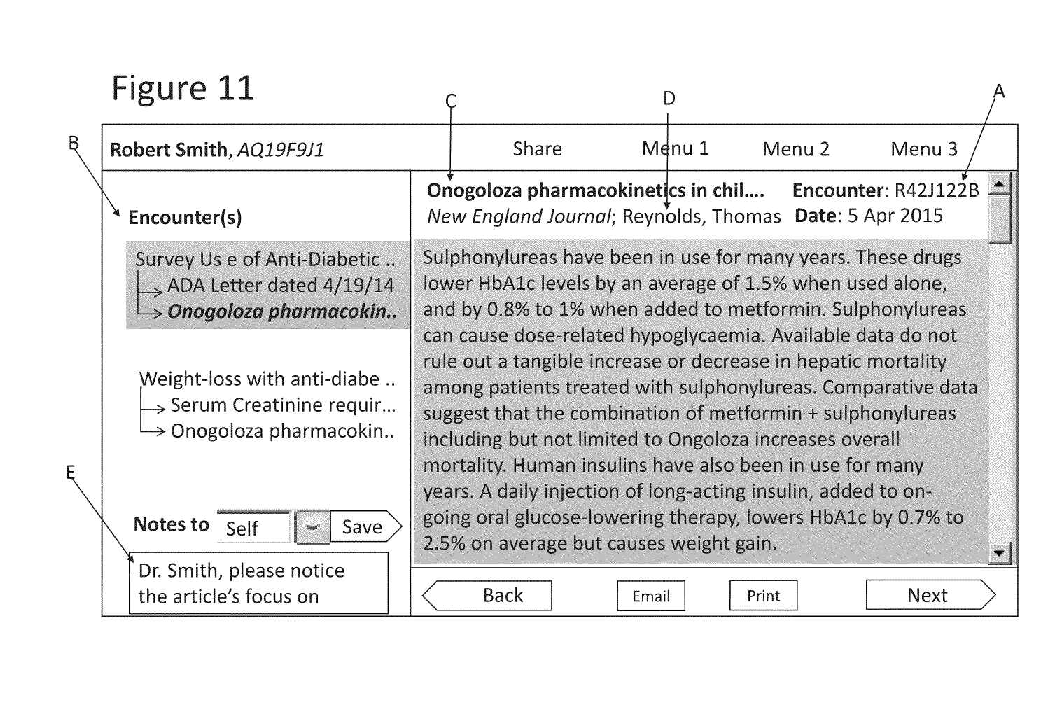

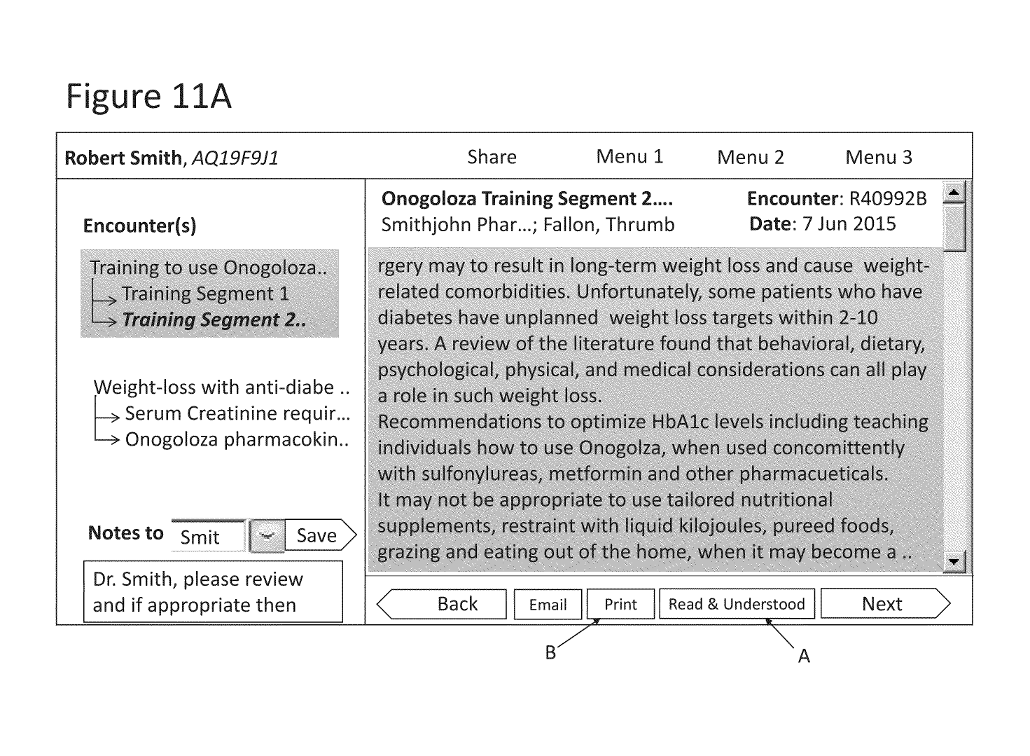

FIG. 11 illustrates an embodiment, as seen by the Caller when the Caller clicks on a specific Encounter. On the left-hand side is a list of Encounters. Upon choosing a specific Encounter, such as Encounter R42J122B (As shown by arrow “A” in FIG. 11), studies made available during that Encounter will appear. These marked studies will be specific to the selected Encounter.

FIG. 11 illustrates the operation of an embodiment from the viewpoint of the Caller when the Caller views a Document supplied by the Company. A similar screen may be viewed by a Representative when reviewing previous Encounters. If a Document is marked by the Company Representative, as shown in FIG. 5, and is chosen to be viewed by a Caller, the full text of the Document will be seen on the right-hand side of the screen. The Encounter in question (A), and the Document chosen, with information such as the relevant journal (C), authors (D) etc., may be highlighted and/or displayed on the top right hand side.

As described above, if a Caller so desires, he or she can tag, highlight, annotate, or write comments and attach them to a Document. A Caller may also share a specific Encounter or Document with others for review. If a new copy of the Document is shared, the receiving Caller may be informed, if appropriate, that there may be a “transfer of value” and therefore a deemed payment attributable to him/her under the Sunshine Act. Such a notification may be shown at or on the screen, or may be seen when the Caller tries to leave this screen in the form of a pop-up, which may or may not need to be acknowledged and/or agreed to. Assuming a new copy of the document is shared, one less copy of the reprint will be available for other sharing purposes. For example, if a Company purchases 50 reprints from a publisher, and 10 of those reprints are shared by Callers, only 40 reprints will be available for future sharing purposes during the Rental Period.

As shown in FIG. 11A, a Caller can also choose to print a specific link or Document to himself or others for review (B). In the same manner described above, the Company may inform the Caller if the Caller is subject to the transfer of value requirements established by the Sunshine Act. In such an event, one copy of a reprint will not be available for other sharing purposes. For example if a Company purchases fifty (50) reprints from a publisher, and five (5) of those reprints are printed, only forty five (45) reprints will be available for future sharing purposes.

Depending on a Company's internal policies, a Company's sharing of a Document might only constitute a potential transfer of value. In some situations, even if the recipient is considered a potential recipient of a transfer of value under the Sunshine Act, if a link to a Document is not clicked on, no transfer of value will be said to have occurred. Hence, such unopened Documents will not be part of a tally of Documents or monies that were part of a transfer of value to that recipient.

From time to time, a Company may decide that it wants a Caller to acknowledge reading and/or understanding a Document. Such a need may occur in various contexts, including trainings or education required under a Risk Evaluation Mitigation Strategies (REMS) program. In the context of such trainings, it may be appropriate to ensure that a physician has read a specific REMS program or ensure that a recipient has read and understood the training Such a “Read and Understood” button (A) may be shown on the screen, as illustrated in FIG. 11A, or may be seen when a Caller tries to leave the screen, in the form of a pop-up. Additionally, if appropriate, such training may also be combined with testing to ensure that the training has appropriately been conducted.

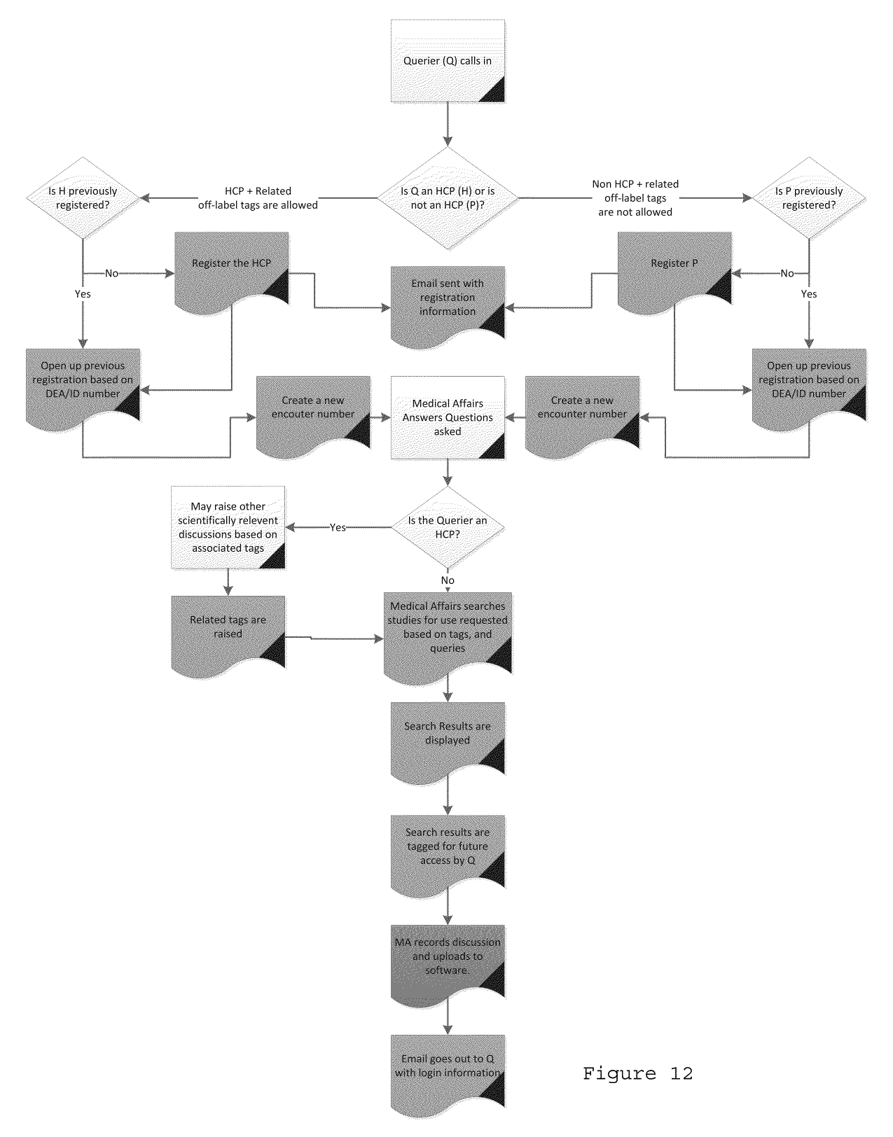

The process described above is summarized in the flow chart of FIG. 12. The flow chart illustrates the steps taken when a Caller, designated “Querier (Q)” in the flow chart, telephones the Company (1202). FIG. 12 shows that the Caller, if not already registered, is registered into the system, either as a healthcare provider or a non-healthcare provider, designated “HCP (H)” and “P” in the flow chart, respectively, thereby providing indications to the Company Representative as to what kind of information may be released to the Caller. While FIG. 12 illustrates the steps of a Caller reaching out to a Company, it is equally possible for a Company to reach out to a Caller to initiate an Encounter.

The flow chart of FIG. 12 shows the creation of an Encounter number. The Encounter then proceeds with a search, conducted by the Medical Affairs Representative, designated “MA” in the flow chart, or other Company Representative, and the display and tagging of the search results. The Encounter typically ends by sending an email to the Caller, as described above with regard to FIG. 6A, providing information to enable the Caller to enter the database later and peruse the items retrieved from the search.

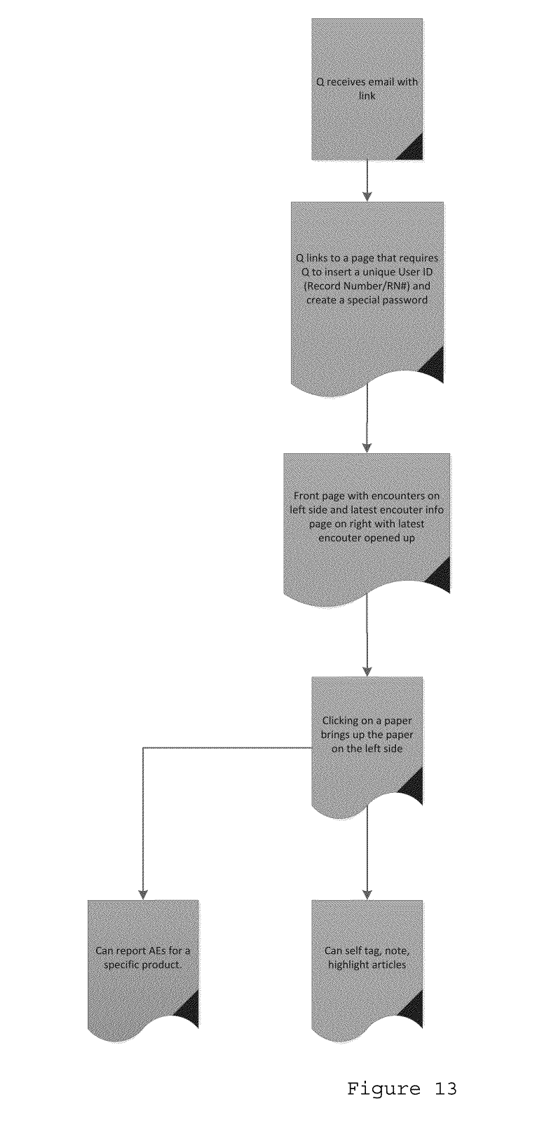

FIG. 13 summarizes the steps performed by the Caller, designated “Q” in the flow chart, after having spoken with the Representative. The Caller receives an email with a pertinent link and uses that link to enter a database, which will require authentication to enter. When the Caller enters the required information, he or she is provided with the information resulting from the Encounter with the Company Representative. The Caller is presented various items obtained from the database search discussed above, and the Caller can click on desired items, and obtain the full text, self tag, note, or highlight the articles and/or report adverse events, designated “AEs” in the flowchart, for a specific product.

The above-described steps result in creation of a database of information, which the Company may use to gain insight into how its Products are used. For example, the Company can determine the level of interest in various on-label and off-label uses of a pharmaceutical product. The Company can also track the movement of healthcare providers or members of the general public as they spend time viewing various items on the database.

More specifically, embodiments of the present invention may enable the Company to answer questions such as the following:

1) What types of off-label uses receive the most views from Callers?

2) Who is viewing the data?

3) How often is the data viewed?

4) When is the data viewed?

5) What medium (i.e. mobile or desktop) is used to view data?

6) What is impacting the data?

7) What impact does the data have?

8) Who impacts the data?

9) Does the review of one or more Documents affect the prescribing of an individual product, as may be evaluated by following the prescribing habits of an individual or Group of individuals before and after reading one or more Documents?

10) Was there acknowledgement of opening, reviewing and/or understanding a specific training program made available?The answers to these questions may provide the Company with grounds for making new applications for approval of new uses for its Products.

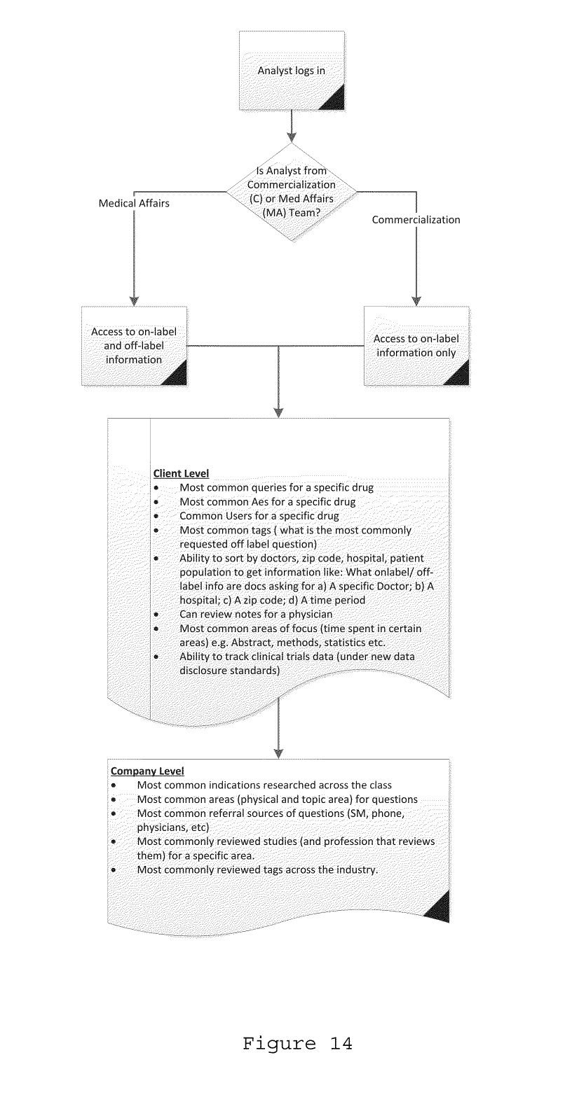

FIG. 14 provides a flow chart that summarizes analyses which can be performed using data generated by operation of an embodiment.

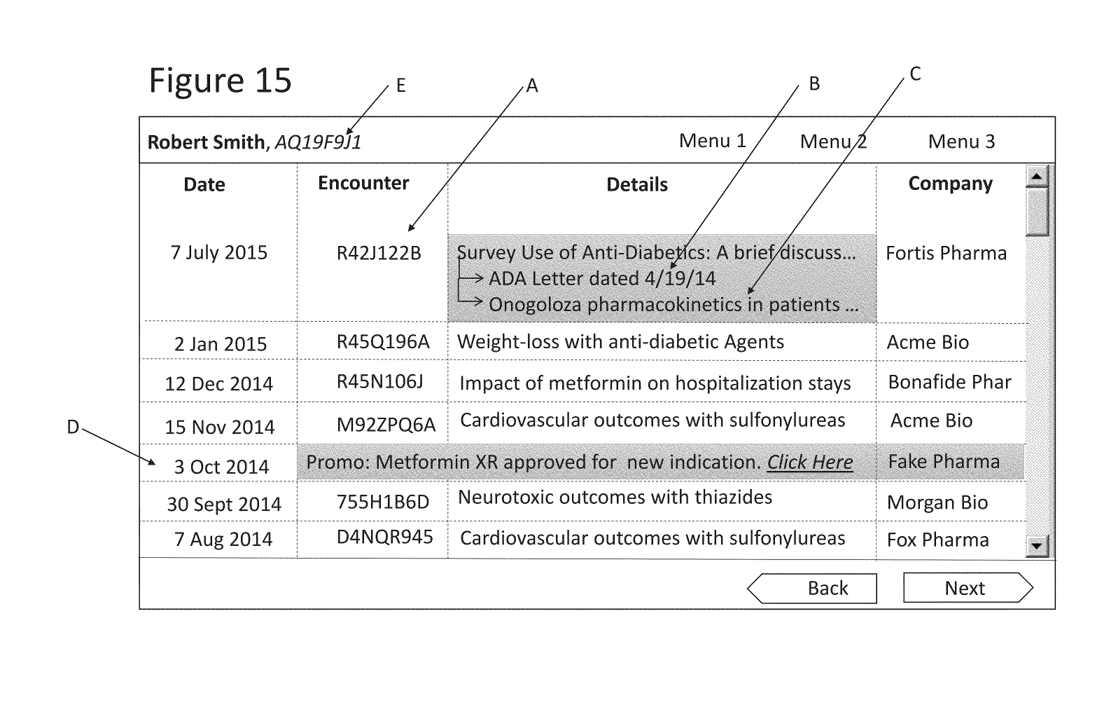

FIG. 15 is a sample view for a Caller who has received various Documents as shared by one or more companies. In this example view, Encounter R42J122B (A) is expanded to provide details of Encounter including the specific Documents that were shared. In the context of this Encounter R42J122B, the ADA Letter dated Apr. 19, 2014 (B) and the Document with a title beginning with “Onogoloza pharmacokinetics in patients . . . ” (C) were shared. None of the other Encounters were expanded in the context of this example.

In FIG. 15, on Oct. 3, 2014, (D) a promotional piece was shared with Dr. Robert Smith, who has identification number AQ19F9J1 (E). These promotional pieces can be targeted by companies to specific Users or Groups of Users that meet specific criteria. Such criteria may include specific Groups and/or additional filters such as zip codes, a sales agent's territory, etc. Additional details, such as the viewing history of a document in the Encounter, may also represent available fields.

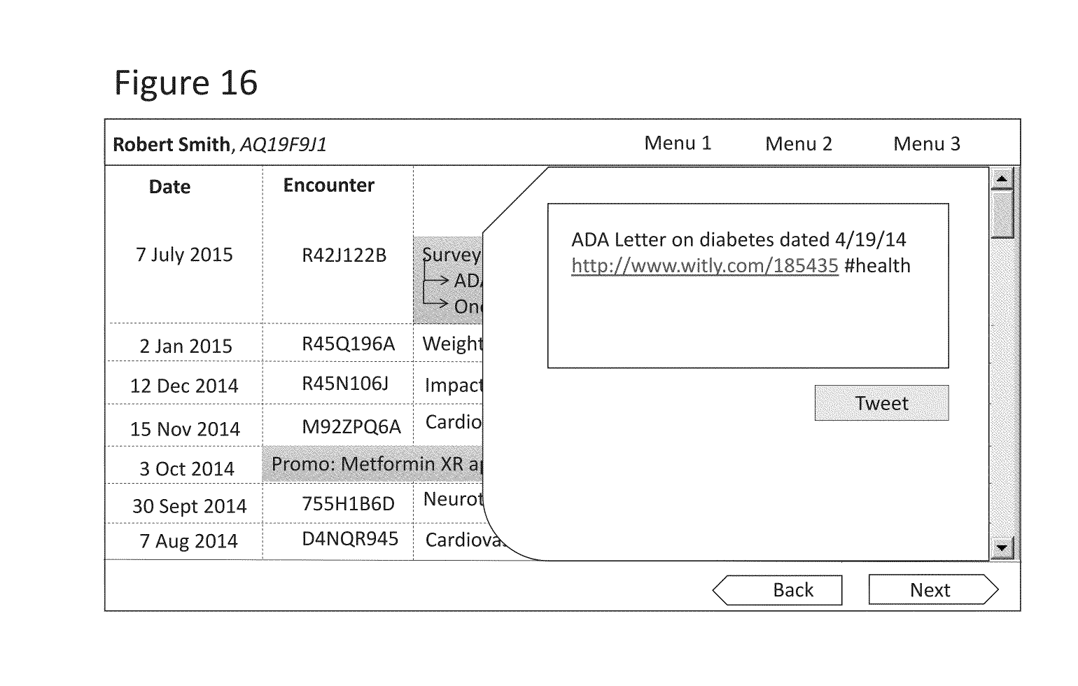

FIG. 16 illustrates the screen of a Caller who has chosen to share a Document and/or Encounter over social media. In the embodiment shown in FIG. 16, a Caller has chosen to tweet a link to an ADA diabetes letter that was previously shared with him. For example, as shown in FIG. 16, a tweet may be sent saying, “ADA Letter on diabetes dated Apr. 19, 2014 http://www.witly.com/185435 #health”. In such an event, the Document, subject to the intent of the Company, may be shared in one of two primary ways: (1) the copy of the Document provided to the initial sharer is shared; or (2) another copy of the Document is shared, provided sufficient numbers of copies of Documents are available for sharing in the Vault and such distribution is authorized by the Company and appropriate laws and regulations. In the case of (1), the initial sharer cannot access the Document during the Rental Period for the shorter of (a) the Rental Period during which the Document was shared or (b) a temporary Rental Period granted by the sharer. In the case of (2), additional copies of the Document are made available for each person who appropriately registers, authenticates, and accesses the Document. If required under the Company's policies, an appropriate transfer of value will be stated to have occurred and will be charted against the person who received and/or reviewed the Document. Once the available number of copies is exhausted, the next person to request access to a Document will be notified that no additional copies of the Document are available and will then be notified of the first opportunity additional copies of the Document will be available.

Alternatively, it is also possible that a Caller with whom a Document has been shared can choose to share the Document with other Users subject to the terms of the Company that originally shared the Document with the Caller. For example, Dr. Samantha Smith, a Caller, can determine that Dr. Jack Jones, a friend, may be interested in a specific Document that has been previously shared with Dr. Smith by a Company. If the Company allows, Dr. Smith can choose to share the Document electronically with Dr. Jones. Depending on the particular configuration, Dr. Smith may simply choose a list of individuals she wants to share the Document with using a screen similar to FIG. 1A, or, for confidentiality purposes, sharing may require an authentication such as a DEA number or email address of the specific recipient.

If the Company has chosen to let the Document expire after a certain period and return to the Vault, the Company may choose to allow the Document to only be shared for the Rental Period remaining for Dr. Smith on the copy of the Document shared with Dr. Smith, or the Company may choose to allow a new Rental Period for Dr. Jones to start. If the Company wishes to apply a new Rental Period, a new copy of the Document may be assigned to Dr. Jones so that only one copy of a Document is shared at any given time, or the lent Document may be unshared from Dr. Smith and the Rental Period would then start for Dr. Jones for the same rental copy of the Document.

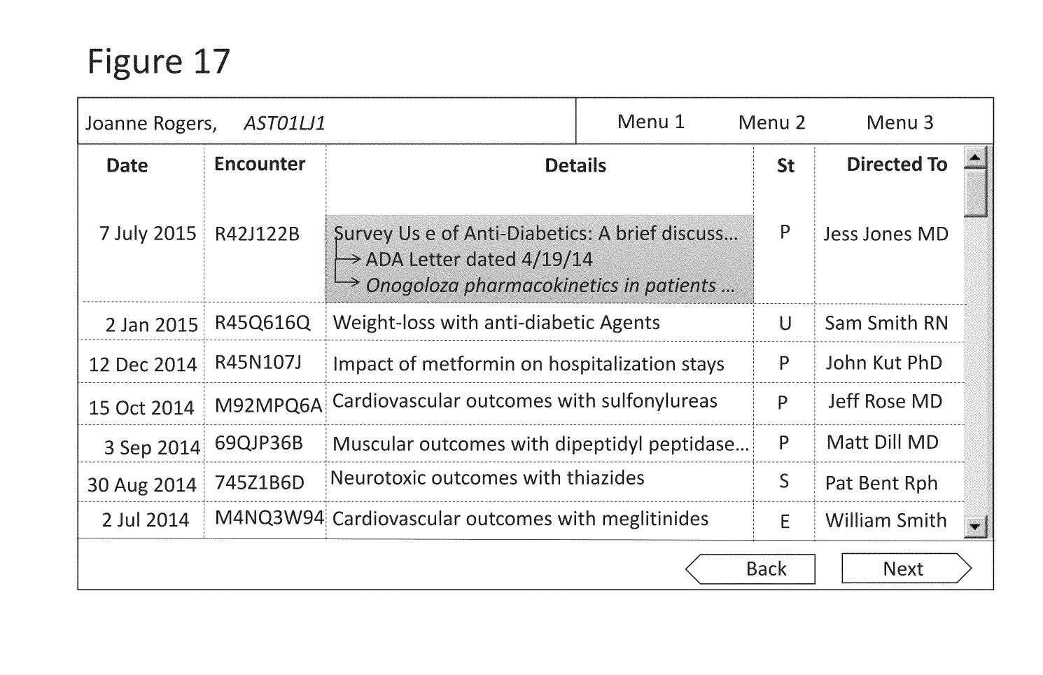

FIG. 17 is an example embodiment of a screen that a Representative may see. The screen details the various Encounters that the Representative has created, modified, appended, or is otherwise related to, and can be filtered to limit the types of Encounters the Representative wishes to focus on, e.g., filters for a specific clinician, filters for saved Encounters, etc. The screen and the associated columns, which can be modified, show the date of the Encounter, the specific Encounter number in question, details of the Encounter, the share status of the Encounter, and the individual or Group to whom the Encounter was directed.

While the “Date”, “Encounter Number”, “Details” and “Directed To” columns are self-explanatory, the Share Status (or “St”) describes the share status of the Encounter as a whole, as opposed to specific Documents shared within the Encounter. In an embodiment, an Encounter may typically have one of the following statuses:

i. Saved (Sa): This status refers to an Encounter that was initiated but was never published. Causes of such a status may include missing Documents, a desire to get additional information prior to sharing, etc. A Saved Encounter would typically either be Published or Deleted.

ii. Published (P): This status refers to an Encounter that was published and remains published and accessible to one or more recipients. However, access to individual Documents within the Encounter may have expired.

iii. Unpublished (U): This status refers to an Encounter that was previously published, but the publication has been withdrawn. This may be caused by a variety of factors, including an inappropriate sharing of information, a need to modify information, etc. If an Encounter is unpublished, a reason must be provided, helping with future compliance issues. Additionally, an unpublished Encounter may be republished if appropriate, provided that a reason for such republication is provided.

iv. Expired (E): This status refers to an Encounter that was previously published, but has timed out and is now inaccessible. This timeout may be caused for a variety of reasons, including but not limited to, zero or limited access within a fixed time frame, lapse of a fixed expiry date of the Encounter from the date of creation of the Encounter, etc.

v. Modified (M): This status refers to an Encounter that was published but has since been modified in some way by a User. Modification may include, but is not limited to, new Comments added to an Encounter that are visible to the User, extending the time during which the Encounter remains available to a Caller, removing Documents, etc.

vi. Shared (Sh): This status refers to an Encounter that was shared with one User but has since been shared by that User with another user, either within an embodiment of this disclosure or using other media, including social media and email.

vii. Deleted (D): This status refers to an Encounter that was never published. Such

Encounters were typically shared and then deleted for one or more reasons. Other statuses may be added as needed.

If a Document within an Encounter, or the Encounter itself, has been shared by a Caller, such shared status of a Document will be available within the Encounter's details. Additional details may also include the date and time of viewing a document.

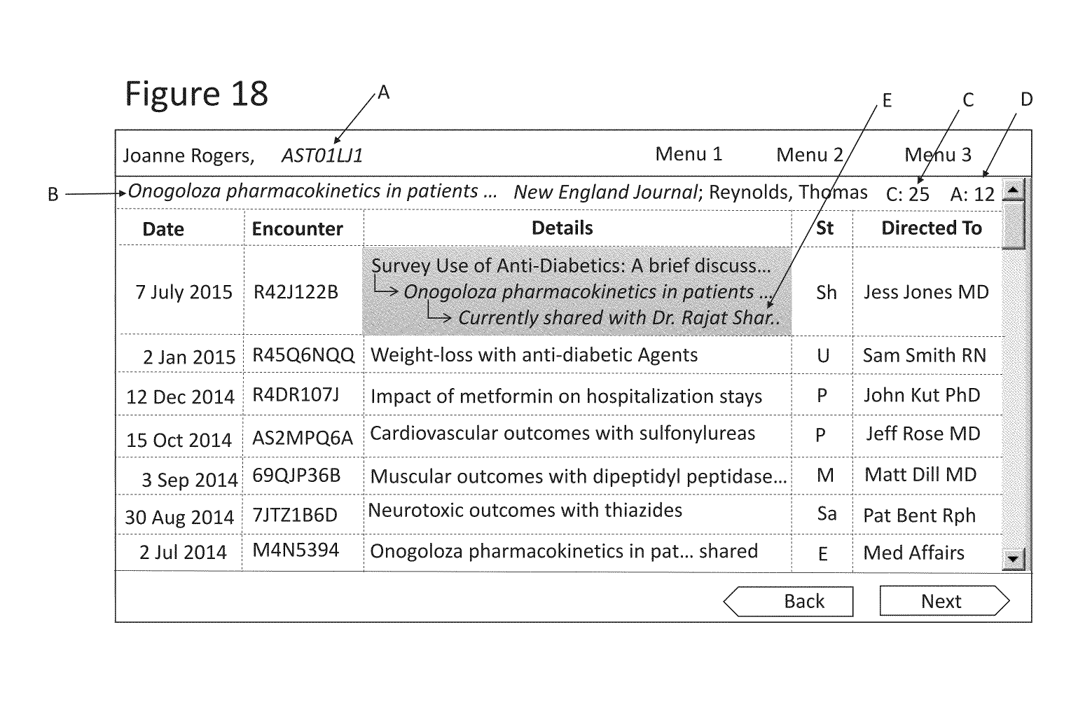

FIG. 18 illustrates a screen in an embodiment that may be available to a Representative. Here, that Representative is Joanne Rogers, with identification number AST01LJ1 (A) of a Company. The screen describes the activity of a Document titled, “Onogoloza pharmacokinetics in patients . . . ” (B) published in the New England Journal and authored by Reynolds and Thomas. As seen in the top right part of the header, 25 total copies/reprints of the Document were obtained for sharing (C) and 12 reprints were still available for sharing (D)—i.e. 13 copies were unavailable for sharing. Documents may be unavailable for sharing for a variety of reasons including, but not limited to: the reprints are currently part of a saved Encounter; one or more reprints are made unavailable for public sharing so that they can be privately used by the Company for viewing, marking up, etc.; the Documents are being shared with Callers; the Documents have been shared by Callers with other individuals; and any other reason consistent with this disclosure.

The columns available may include, and for illustrative purposes may be seen in FIG. 18, the date of the Encounter when a specific Document was shared or otherwise affected, the Encounter Number, the details of the Encounter, the status of the Encounter, and the individual or Group affected. While the “Date” and “Encounter Number” columns are readily understood, the “Details”, “Status”, and “Directed To” Columns require further explanation.

As shown in FIG. 18, Encounter R42J122B is an Encounter where the Document was shared by a Representative with Jess Jones, MD. However, Jess Jones, MD shared the Document with “Dr. Rajat Shar . . . ”. At this screen, a Document will typically have one of the following statuses:

i. Saved (Sa): This status refers to a Document that was part of an initiated Encounter but was never published by the Representative. Causes of such a status may include missing Documents, a desire to get additional information prior to sharing with the intended recipient, etc. This status of the Document allows a Document to be temporarily reserved without it being attributed and/or accessible by the recipient. Accordingly, no transfer of value is attributed in such a situation. However, this status prevents the copy from being reused, and therefore prevents an Encounter from, at the last minute, missing a Document it should have had.

ii. Published (P): This status refers to a Document that is part of a published Encounter and remains published and accessible.

iii. Unpublished (UE): This status refers to a situation where the Encounter itself was unpublished despite being previously published. Resultantly, the Documents within the Encounter, including this Document, were rendered unpublished. This may be caused by a variety of factors including the inappropriate sharing of information, etc. If an Encounter is unpublished, a reason must be provided. Such reasons of un-publication can help with future compliance audits. Importantly, an unpublished Encounter may be republished, if appropriate, provided that a reason for such republication is provided.

iv. Unpublished Document (UD): This status refers to a situation where the Encounter itself is published, but the Document within the Encounter was unpublished despite being previously published. This may be caused by a variety of factors such as inappropriate sharing of information. If a Document is unpublished, a reason must be provided. Such reason for un-publication can help with future compliance issues. Importantly, an unpublished Document may be republished, if appropriate, provided that a reason for such republication is provided.

v. Expired (E): This status refers to a Document that was previously published, but has timed out and is now inaccessible. This timeout may be caused for a variety of reasons, including but not limited to, no access within a fixed time frame, a fixed expiry date of the Encounter from the date of creation of the Encounter, etc.

vi. Modified (M): This status refers to a Document that was published but has since been modified in some way by a User. Modification may include, but is not limited to, new Comments added to a Document that are visible to the User, extending the time during which the Document remains available to a Caller, etc.

vii. Shared (Sh): This status refers to a Document that was shared with one External User but has since been shared by that External User with another External User. This sharing may be facilitated in a variety of ways, including social media, email, direct sharing via embodiments of this disclosure, etc. Other statuses may be added as needed.

If the same Document has been shared to the same User during multiple Encounters during the same Rental Period, only one copy of the Document will be deemed to have been a transfer of value during that Rental Period even though multiple links to that same Document may be accessible to the same User.

The current version of the Sunshine Act requires disclosure of most transfers of items of value made to certain healthcare providers. Such transfers of value may include, but are not limited to, items other than cash, and may include transfers of items such as journal articles. But in embodiments of this disclosure, journal articles, letters addressed to inquiring physicians, and other Documents are not physically transferred to a healthcare provider without the express approval of the recipient. Therefore, it is believed that, the act of merely sharing a Document does not result in a transfer of value. It is further believed that sharing a medical journal article to a physician would not be a reportable event under the Physician Payment Sunshine Act.

Documents may also be set to expire at the end of a fixed period, such as 10 or 30 days, from about 1 day to about 2 years, or any other user-specified amount. When such Documents expire, they return to a Vault of Documents and can be re-lent out if a Company deems appropriate, subject to copyright requirements. Documents that expire serve two major advantages: (1) to the extent a transfer of value has occurred, a temporary sharing of a Document represents a decrease in the value of the transfer of value that may have occurred; and (2) allowing companies to potentially reuse Documents that are not being currently shared thereby minimizing the cost of purchasing reprints. Accordingly, if the transfer of value does not exceed the current $10 per transaction, or $100 per year annual, threshold under the Sunshine Act as it presently exists, such transfers of value may not need to be reported.

An embodiment may also include tracking which specific journal articles are being read and which specific parts of journal articles are deemed to be of special importance or interest, such as abstracts or methods sections. This feature would be useful because it enables companies to consider such information in the future when Documents are being written.

Embodiments may enable a Company to correlate data, such as correlating increases in sales of a specific Product with the reading of Documents relating to such Products. For example, a Company may observe a connection between views of a particular Document and an increase in a Product relating to the subject of that Document, thus showing the Company that it would be advantageous to circulate the Document among practitioners in the relevant field.

Embodiments may also enable a Company to limit access to specific information such that the information may be directed only to specific individuals, and only certain persons or classes of persons may access the information. Such information includes medical information or other related information, such as journal articles, patient diaries, advertising and promotional materials, letters to doctors, information about Product recalls, and specific REMS information. The Company may track which specific individuals opened and accessed the above materials, which specific materials were accessed, how often they were accessed, and what the focus of the review was. That is, Companies may be provided information on specific information in a Document, such as the body or abstract, that was viewed by a healthcare provider.

Embodiments may also provide information on whether specific materials were “scrolled” and/or actively read using active actions like clicking buttons, such as “I accept that I have read this Document”, or tracing scrolling and/or scrolling patterns, and/or answering questions about the Document being reviewed. Analytics regarding the opening, scrolling, and reviewing of information may be tracked individually and in the aggregate for recording and reporting purposes.

Embodiments may also track changes made to Users, Groups, Documents, and Encounters, so that any changes can be verified for their appropriateness by the legal and/or compliance Classes as necessary. In various embodiments, which may be similar to or identical to those disclosed, additional fields may be provided and displayed to Users, and the scope of searches may be expanded or filtered. Further, various sections or portions of screen displays may be removed, added, or relocated as necessary. These and other modifications will be apparent to those skilled in the art.

Embodiments of the present invention provide methods, and systems to perform those methods, to achieve the functionality disclosed herein. A system may comprise a server, and the server may comprise at least one computer communicatively connected to a computer network and communicatively connected to a database. The server may have stored thereon computer instructions that during execution cause the system to perform operations comprising: authenticating a user; receiving at least one file after authenticating the user; storing the at least one file after the receiving; sharing the at least one file after the storing; collecting transfer of value amounts from the sharing; expiring the at least one file after a user-specified period of time; relending the at least one file; and updating the transfer of value amounts.

User authentication may be based upon the class of the user. As discussed above, a Representative may have more rights than a health care provider.

Storing any number of files, comments, transfer of value amounts, or any other persistent data may be performed using the database. Files and data are easily aggregated and searchable using a database, and the collecting and updating of transfer of value amounts may be easily performed using a database.

Sharing may include storing a comment by the user and associating the comment with the at least one file. In this manner, comments may be aggregated and shared between users. Sharing might also involve posts on social media to reach a wider audience.

It may be a goal of an embodiment to update the transfer of value amounts so that the amounts fall below a threshold value, which may be a transaction-reporting value threshold, an annual-reporting value threshold, or any other relevant threshold amount. These thresholds may be related to any applicable laws and regulations, an example of which is the Sunshine Act.

As previously discussed, the at least one file may be any type of relevant file. Examples include a PDF document, word processing document, presentation document, electronic spreadsheet, video file, audio file, training file, testing file, interactive media, HTML Documents, or any combination thereof

Expiring the at least one file may be performed after a time period lapses. This time period might be a Rental Period or any other user-specified time period. Examples include a time period of about 1 day to about 3 years, about 3 days to about 90 days, or any other pertinent time period.

Embodiments may also include the server having stored thereon computer instructions that during execution cause the system to perform operations comprising: authenticating a representative; receiving at least one file after authenticating the representative; storing the at least one file after the receiving; sharing the at least one file with at least one user after the storing; tracking user data of the at least one file by the at least one user from the sharing; and cross-referencing the tracked user data with external database information associated with the at least one user.

Authenticating a representative may be based upon the class of the individual logging-in. For example, as discussed above, a Representative may have more rights than a Promotional Manager.

Storing any number of files, comments, user data, file data, or any other persistent data may be performed using the database. Files and data are easily aggregated and searchable using a database, and the tracking and cross-referencing of user data may be easily performed using a database.

Sharing may include storing a comment by the user and associating the comment with the tracked user data. In this manner, comments may be aggregated and associated to users and files. Sharing might also involve posts on social media to reach a wider audience.

Users may be either healthcare professionals or non-healthcare professionals, and tracked user data might include a user name, user identification information, number of times a file was shared, whether the file was opened, whether the end of the file was reached, or any combination thereof User identification information might include a name, DEA number, NPI number, zip code, and any other type of identifying information.

As previously discussed, the at least one file may be any type of relevant file. Examples include a PDF document, word processing document, presentation document, electronic spreadsheet, video file, audio file, training file, testing file, interactive media, HTML Documents, or any combination thereof.

The external database information might come from any relevant database, including, for example, an IMS database or Doctors of Pharmacy database. These databases may include prescribing information relating to data of specific products and/or how users are prescribing the products. Cross-referencing the tracked user data with this external information allows embodiments to aggregate data related to products and users and perform meaningful analysis on that data.

Embodiments may also include the server having stored thereon stored thereon computer instructions that during execution cause the system to perform operations comprising: authenticating a representative; receiving at least one training file after authenticating the representative; storing the at least one training file after the receiving; sharing the at least one training file with at least one user after the storing; tracking data of the at least one training file by the at least one user from the sharing; and reporting the tracked data.

Again, authenticating a representative may be based upon the class of the individual logging-in. For example, a Representative may have more rights than a Promotional Manager.

Storing any number of files, comments, user data, file data, or any other persistent data may be performed using the database. Files and data, including training files and training data, are easily aggregated and searchable using a database, and the tracking and reporting of data may be easily performed using a database.

Sharing may include storing a comment by the user and associating the comment with the tracked data. In this manner, comments may be aggregated and associated to users and files. Sharing might also involve posts on social media to reach a wider audience.

Users may be either healthcare professionals or non-healthcare professionals, and tracked data might include a user name, user identification information, number of times a training file was shared, whether the training file was opened, whether the end of the training file was reached, or any combination thereof. User identification information might include a name, DEA number, NPI number, zip code, and any other type of identifying information.

Training files may have content related to prescription drug uses and effects of a product. Such content may inform a user of dosage guidelines, adverse effects, correct uses, incorrect uses, and any other information relevant to the product. Tracking and reporting data associated with such files along with the users viewing those files may be used for quality assurance purposes. For example, companies or regulatory administrations may want to ensure that any users prescribing the product are aware of the content in the training file. To ensure the user has read and understood the content, a company may test a user of the content and require that the user receive at least a minimum grade to pass the test. If the user receives at least the minimum grade and passes the test, the user may then be allowed to prescribe, dispense, or otherwise use the product. Such quality assurance may be especially important for FDA REMS compliance.

When ranges are used herein, all combinations and subcombinations of ranges for specific embodiments therein are intended to be included.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1-29. (canceled)

30. A system comprising:
a server, the server comprising at least one computer communicatively connected to a computer network and communicatively connected to a database, the server having stored thereon computer instructions that during execution cause the system to perform operations comprising:
authenticating a user;
receiving at least one file after authenticating the user;
storing the at least one file after the receiving;
sharing the at least one file after the storing;
collecting transfer of value amounts from the sharing;
expiring the at least one file after a user-specified period of time;
relending the at least one file; and
updating the transfer of value amounts.

31. The system of claim 30 wherein the updating the transfer of value amounts lowers the amounts below a threshold value.

32. The system of claim 31 wherein the threshold value is the transaction-reporting value threshold.

33. (canceled)

34. The system of claim 30 wherein the at least one file is a PDF document, word processing document, presentation document, electronic spreadsheet, video file, audio file, training file, testing file, interactive media, HTML Documents, or any combination thereof.

35. The system of claim 30 wherein the user-specified period of time is in the range of from about 1 day to about 3 years.

36. (canceled)

37. The system of claim 30 wherein the sharing further comprises:
storing a comment submitted by the user; and
associating the comment with the at least one file.

38. The system of claim 30 wherein the at least one file is searchable.

39. The system of claim 30 wherein the sharing is performed via social media.

40. (canceled)

41. The system of claim 30 wherein the storing of the at least one file is performed via the database.

42. The system of claim 30 wherein the collecting transfer of value amounts is performed via the database.

43. (canceled)

44. A system comprising:
a server, the server comprising at least one computer communicatively connected to a computer network and communicatively connected to a database, the server having stored thereon computer instructions that during execution cause the system to perform operations comprising:
authenticating a representative;
receiving at least one file after authenticating the representative;
storing the at least one file after the receiving;
sharing the at least one file with at least one user after the storing;
tracking user data of the at least one file by the at least one user from the sharing; and
cross-referencing the tracked user data with external database information associated with the at least one user.

45. The system of claim 43 wherein the tracked user data includes a user name, user identification information, number of times shared, whether the file was opened, whether the end of the file was reached, or any combination thereof.

46. (canceled)

47. The system of claim 43 wherein cross-referencing includes comparing the tracked user data of the at least one user with prescribing information associated with the at least one user.

48. (canceled)

49. The system of claim 43, the server having stored thereon computer instructions that during execution cause the system to perform operations further comprising:
storing a comment submitted by the at least one user; and
associating the comment with the tracked user data.

50-52. (canceled)

53. The system of claim 43 wherein the authenticating is based upon a class of the representative.

54. (canceled)

55. The system of claim 43 wherein the tracking user data of the at least one file is performed via the database.

56. A system comprising:
a server, the server comprising at least one computer communicatively connected to a computer network and communicatively connected to a database, the server having stored thereon computer instructions that during execution cause the system to perform operations comprising:
authenticating a representative;
receiving at least one training file after authenticating the representative;
storing the at least one training file after the receiving;
sharing the at least one training file with at least one user after the storing;
tracking data of the at least one training file by the at least one user from the sharing; and
reporting the tracked data.

57. (canceled)

58. The system of claim 56 wherein the reporting the tracked data is used for FDA REMS compliance.

59. The system of claim 56 wherein a first file of the at least one training file has content related to prescription drug uses and effects of a product.

60. The system of claim 59 the server having stored thereon computer instructions that during execution cause the system to perform operations further comprising:
testing a first user of the at least one user on the content of the first file;
requiring the first user to receive at least a minimum grade to pass the testing; and
if the first user receives at least the minimum grade:
allowing the first user to prescribe, dispense, or otherwise use the product.

61-65. (canceled)
